(19) United States
(12) Patent Application Publication
(10) Pub. No.: US 2022/0046231 A1
(43) Pub. Date: Feb. 10, 2022

(54) VIDEO ENCODING/DECODING METHOD AND DEVICE

(71) Applicant: SZ DJI TECHNOLOGY CO., LTD., Shenzhen (CN)

(72) Inventors: Yan ZHOU, Shenzhen (CN); Xiaozhen ZHENG, Shenzhen (CN)

(21) Appl. No.: 17/509,343

(22) Filed: Oct. 25, 2021

Related U.S. Application Data
(63) Continuation of application No. PCT/CN2019/084683, filed on Apr. 26, 2019.

(51) Int. Cl. H04N 19/103; H04N 19/176; H04N 19/70; H04N 19/593; H04N 19/147; H04N 19/119; H04N 19/186

(52) U.S. Cl. CPC H04N 19/103; H04N 19/176; H04N 19/70; H04N 19/186; H04N 19/147; H04N 19/119; H04N 19/593

(57) ABSTRACT

A video encoding method includes selecting a pulse code modulation (PCM) mode to encode a coding block in a frame to be encoded, and indicating the PCM mode in a syntax element of intra-frame prediction mode of the coding block.

### CROSS-REFERENCE TO RELATED APPLICATION

This application is a continuation of International Application No. PCT/CN2019/084683, filed Apr. 26, 2019, the entire content of which is incorporated herein by reference.

### TECHNICAL FIELD

The present disclosure relates to the field of information technologies and, more particularly, to a video encoding/decoding method and device.

### BACKGROUND

To reduce bandwidth occupied by video storage or transmission, video data needs to be encoded and compressed. In existing encoding techniques, a video encoding and compression process includes: block division, prediction, transformation, quantization, and entropy encoding. This process forms a hybrid video encoding framework. Based on this hybrid video encoding framework, after decades of development, video encoding and decoding technology standards have been gradually formed. Some mainstream video encoding and decoding standards, such as high-efficiency video encoding (HEVC) standard and the latest versatile video coding (VVC) standard, introduce a pulse code modulation (PCM) encoding and decoding technology. When an intra-frame prediction mode is used for encoding, the PCM mode is introduced and an independent syntax element is used to indicate the PCM mode. The PCM encoding mode can skip the processes of prediction, transformation, quantization, and entropy encoding, and directly write original pixels into a code stream or write high-order parts into the code stream. In a decoding process, when a PCM syntax element is obtained by decoding, it means that a current coding unit uses PCM mode for decoding, and subsequent processes of inverse quantization, inverse transformation, and prediction can be skipped to directly decode the code stream for reconstruction.

In the existing technologies, an independent syntax element is generally used to indicate the PCM mode for the PCM encoding technology applied to the video encoding system. Correspondingly, a new syntax element needs to be added to represent the PCM encoding mode, which will increase bit consumption. Further, the PCM encoding mode is only applied in the intra-frame prediction mode, and at the same time, luminance components and chrominance components in the coding unit are bundled for using. The flexibility and encoding efficiency of the predictive encoding of the luminance components and the chrominance components are limited.

Therefore, an adaptive PCM encoding and decoding method is needed to improve the flexibility of PCM encoding and decoding technology application, reduce bit consumption, and improve encoding efficiency.

### SUMMARY

In accordance with the disclosure, there is provided a video encoding method including selecting a pulse code modulation (PCM) mode to encode a coding block in a frame to be encoded, and indicating the PCM mode in a syntax element of intra-frame prediction mode of the coding block.

In accordance with the disclosure, there is also provided a video decoding method including obtaining a code stream of a coding block of a frame to be decoded that includes an encoded syntax element of intra-frame prediction mode of the coding block and encoded pixel information of the coding block, decoding the encoded syntax element to obtain a syntax element of intra-frame prediction mode of the coding block, determining a pulse code modulation (PCM) mode according to the syntax element, and decoding the encoded pixel information according to the PCM mode.

### BRIEF DESCRIPTION OF THE DRAWINGS

FIG. 1 is a schematic flow chart of a video encoding method.

FIG. 2 is a schematic diagram of a block division consistent with the present disclosure.

FIG. 3 is a schematic flow chart of a video encoding method consistent with the present disclosure.

FIG. 4 is a schematic flow chart of another video encoding method consistent with the present disclosure.

FIG. 5 is a schematic flow chart of another video encoding method consistent with the present disclosure.

FIG. 6 is a schematic flow chart of another video encoding method consistent with the present disclosure.

FIG. 7 is a schematic flow chart of another video encoding method consistent with the present disclosure.

FIG. 8 is a schematic flow chart of another video encoding method consistent with the present disclosure.

FIG. 9 is a schematic diagram of division of a frame to be encoded consistent with the present disclosure.

FIG. 10 is a schematic flow chart of another video encoding method consistent with the present disclosure.

FIG. 11 is a schematic flow chart of another video encoding method consistent with the present disclosure.

FIG. 12 is a schematic flow chart of another video encoding method consistent with the present disclosure.

FIG. 13 is a schematic flow chart of another video encoding method consistent with the present disclosure.

FIG. 14 is a schematic flow chart of a video decoding method consistent with the present disclosure.

FIG. 15 is a schematic flow chart of another video decoding method consistent with the present disclosure.

FIG. 16 is a schematic flow chart of another video decoding method consistent with the present disclosure.

FIG. 17 is a schematic flow chart of another video decoding method consistent with the present disclosure.

FIG. 18 is a schematic flow chart of another video decoding method consistent with the present disclosure.

FIG. 19 is a schematic flow chart of another video decoding method consistent with the present disclosure.

FIG. 20 is a schematic block diagram of a video encoding device consistent with the present disclosure.

FIG. 21 is a schematic block diagram of another video encoding device consistent with the present disclosure.

FIG. 22 is a schematic block diagram of a video decoding device consistent with the present disclosure.

FIG. 23 is a schematic block diagram of another video decoding device consistent with the present disclosure.

### DETAILED DESCRIPTION OF THE EMBODIMENTS

The technical solutions in the embodiments of the present disclosure will be described below in conjunction with the drawings in the embodiments of the present disclosure. Obviously, the described embodiments are some of the embodiments of the present disclosure, but not all of the embodiments. Based on the embodiments in this disclosure, all other embodiments obtained by those of ordinary skill in the art without creative work shall fall within the scope of this disclosure.

The various embodiments of the present disclosure can be applied in a standard or non-standard image or video encoder, such as an encoder under an audio-video coding standard (AVS).

The sequence numbers used in embodiments of the disclosure for various processes do not indicate the order of execution. The execution order of various processes should be determined by their functions and internal logic, and should not constitute limitation to the embodiments of the present disclosure.

Unless otherwise specified, all technical and scientific terms used in the embodiments of the present disclosure have the same meaning as commonly understood by those skilled in the technical field of the present application. The terms used in this disclosure are only for the purpose of describing specific embodiments, and are not intended to limit the scope of this application. The phrase “and/or” used in this disclosure includes any and all combinations of one or more associated items that are listed.

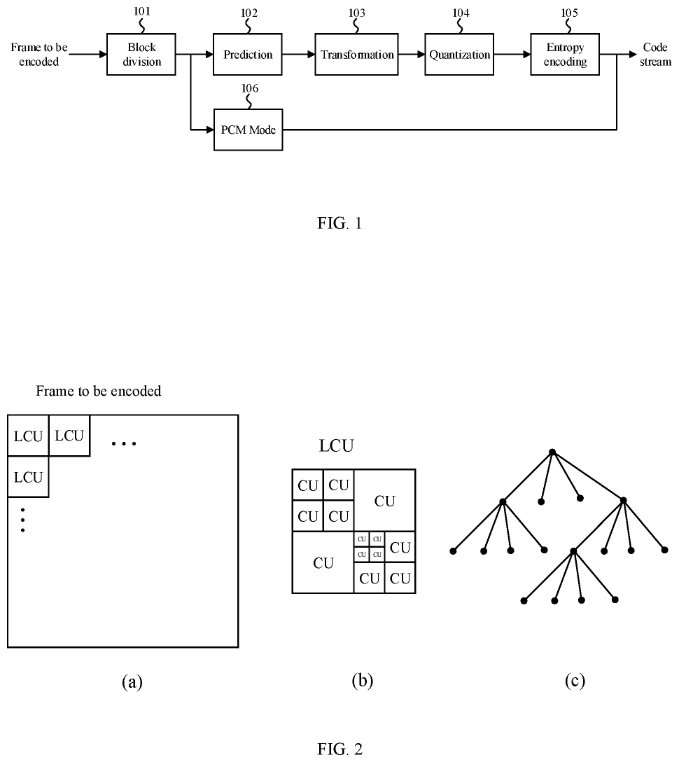

FIG. 1 is a schematic flow chart of a video encoding method.

As shown in FIG. 1, after receiving a frame to be encoded (also referred to as a “to-be-encoded frame” or a “target frame”) of a video, the video encoding method includes block division 101, prediction 102, transformation 103, quantization 104, and entropy encoding 105, and eventually outputting a code stream of the frame to be encoded. A decoding process usually decodes a received code stream according to inverse processes of the above processes, to restore frame information of the video before decoding.

The block division 101 includes performing block division on a current frame to be encoded. Before encoding or compressing an image, the image may be divided into a plurality of image blocks. Further, various image blocks in the plurality of image blocks may be divided again into a plurality of image blocks, and so on. A number of division levels may be different in different encoding methods and operation methods may also be different correspondingly. In different encoding standards, names of image blocks in one same division level may be different. For example, as shown in part (a) of FIG. 2, the frame to be encoded is divided into a plurality of largest coding units (LCUs) that do not overlap with each other. Each LCU can be further divided into a plurality of smaller coding units (CUs) according to a quadtree mode. As shown in part (b) of FIG. 2, one LCU can be divided into a plurality of CUs with different sizes. Part (c) of FIG. 2 shows a division structure of the quadtree mode. One CU includes a plurality of coding blocks (CBs) and relevant syntax elements. One coding block includes one luminance coding block and two corresponding chrominance coding blocks.

In some examples, one CU may also include a prediction unit (PU) and a transform unit (TU) associated with the CU, where the PU is the basic unit for prediction 102, and the TU is the basic unit for transformation 103 and quantization 104. In some examples, the PU and TU are respectively obtained by dividing the CU into one or more blocks. The PU may contain a plurality of prediction blocks (PB) and related syntax elements, where one prediction block may include one luminance prediction block and two corresponding chrominance prediction blocks. In some examples, the PU and TU may be the same, or they may be obtained by dividing the CU through different division methods. In some examples, at least two of the CU, PU, and TU may be the same. For example, the CU, PU, and TU are not distinguished, and prediction, quantization, and transformation are all performed in units of the CU.

The prediction process 102 is mainly used to remove spatial and temporal redundant information of the current frame to be encoded. Currently, the commonly used predictive encoding methods include intra-frame prediction and inter-frame prediction.

The intra-frame prediction process includes: obtaining reconstructed pixels of neighboring blocks around one current block to be encoded (also referred to as “to-be-encoded block” or “target block”) as reference pixels; using the prediction mode method to calculate predicted values and generate a prediction block; subtracting corresponding pixel values of the block to be encoded and the prediction block to obtain residual; and combine obtained residuals corresponding to various blocks to be encoded to obtain the residual of the unit to be encoded.

There are a plurality of prediction mode methods. In one example, the prediction mode for a luminance prediction unit includes at least one of a direct current (DC) prediction mode, a planar (Planar) prediction mode, or different angular prediction modes (for example, 33 angular prediction modes in total). In one example, the prediction mode for a chrominance prediction unit includes at least one of a horizontal prediction mode, a vertical prediction mode, a DC prediction mode, a luminance derivation prediction mode (DM), or a linear prediction mode (LM). The DM mode involves determining the chrominance prediction mode according to the luminance prediction mode, for example, setting the chrominance prediction mode to be the same as the finally adopted luminance prediction mode. The LM mode involves predicting the chrominance of the current block based on a linear model relationship between the luminance and chrominance of adjacent blocks.

In another example, the prediction mode for a luminance prediction unit includes at least one of a direct current (DC) prediction mode, a planar prediction mode, a bilinear prediction mode, or different angular prediction modes (for example, 33 angular prediction modes in total). In one example, the prediction mode for a chrominance prediction unit includes at least one of a DM mode, a DC prediction mode, a horizontal prediction mode, a vertical prediction mode, a bilinear prediction mode, or a two-step cross-component prediction mode (TSCPM).

The inter-frame prediction includes: searching for an image block that best matches the current block to be encoded in a reference image as a prediction block; subtracting the corresponding pixel values of the block to be encoded and the prediction block to obtain the residual; and combining residuals corresponding to various blocks to be encoded together to obtain the residual of the unit to be coded.

After the residual is generated through predictive encoding, the encoding method of the transformation 103 can be used to remove correlation of the residuals of the image blocks, to improve the encoding efficiency. For the transformation of the residual data of the block to be encoded, two-dimensional discrete cosine transform (DCT) or two-dimensional discrete sine transform (DST) are usually used. For example, the residual information of the block to be encoded is respectively multiplied by an N×M transformation matrix and a transposed matrix of the, and the transformation coefficients of the block to be encoded are obtained after the multiplication.

After generating the transformation coefficients, the quantization 104 can be used to further improve the compression efficiency. The transformation coefficients can be quantized to obtain quantized coefficients, and then the entropy encoding, such as context adaptive binary arithmetic encoding (CABAC), can be performed on the quantized coefficients. Finally, a bit stream obtained by entropy encoding and the encoding mode information generated during the predictive encoding process, such as the bit stream generated by performing entropy encoding on information including intra-frame prediction mode or motion vector information, are stored or sent to a decoding end.

Correspondingly, in the decoding process, the entropy encoded bit stream of the current image block is obtained and then entropy decoding is performed. After inverse quantization and inverse transformation, the reconstructed residual is obtained. According to the intra-frame prediction mode or motion vector information obtained by decoding, the prediction block corresponding to the current image block is obtained. Then the reconstructed residual is added to the prediction value of the prediction block to obtain the reconstructed pixel values of various pixels in the current image block.

Optionally, when encoding with the inter-frame prediction mode and CU=PU, that is, when one CU is not divided into a plurality of PUs during the block division, the PCM mode 106 is included. Encoding with the PCM mode can achieve lossless encoding. Further, in some special cases, especially when the image content is irregular or the quantization parameter is very low, this mode is more efficient than the operation including intra-frame prediction-transform-quantization-encoding. As shown in FIG. 1, when the CUs in the frame to be encoded adopt the PCM mode, the CUs do not go through the processes of prediction, transformation, quantization, and entropy encoding. Instead, the pixel values of the CUs are directly transmitted to the decoding end. In the same way, the decoding end does not need to go through the processes of prediction. Instead, the pixel values are directly read out from the code stream.

In some examples, when the CU size is larger than or equal to a CU size parameter set in the sequence parameter set (SPS), the CU can be encoded in the I_PCM mode, and an independent syntax element is used to indicate the PCM mode. But in this way, adoption of the PCM mode will increase certain bit consumption.

Therefore, based on the above problems, the present disclosure provides an adaptive PCM encoding/decoding technology. In the present disclosure, by using reserved prediction mode bits to indicate the PCM mode, the bit consumption may be reduced, and the flexibility and encoding efficiency of video encoding/decoding processes may be improved.

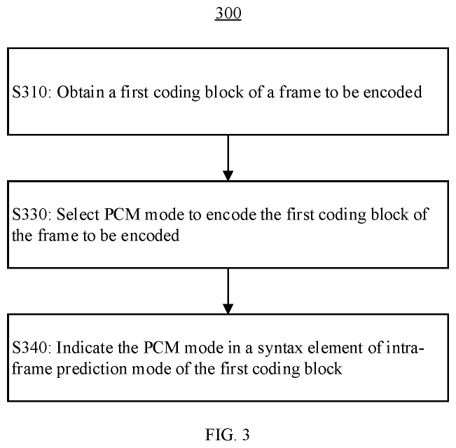

One embodiment of the present disclosure in FIG. 3 provides a video encoding method 300. As shown in FIG. 3, the method 300 includes S310 to S340.

At S310, a first coding block of a frame to be encoded is obtained.

At S330, the PCM mode is selected to encode the first coding block of the frame to be encoded.

At S340, the PCM mode is indicated in a syntax element of an intra-frame prediction mode of the first coding block.

In the video field, a movie, television, digital video, etc. can be regarded as a plurality of images that continuously change over time. A frame may be one image of the plurality of images. The frame to be encoded may be a frame in the video to be encoded (also referred to as “to-be-encoded video” or “target video”), that is, one image to be encoded (also referred to as “to-be-encoded image” or “target image”). The frame to be encoded may be divided to form a plurality of image blocks. The plurality of image blocks may be used as units for encoding, and one image block of the plurality of image blocks may be considered as one coding block.

In the present disclosure, the frame to be encoded may be any one image in the video to be encoded. The frame to be encoded may include a plurality of coding blocks, and the first coding block may be any one of the plurality of coding blocks in the frame to be encoded. The present disclosure has no limit on the position of the first coding block in the plurality of coding blocks and the size of the first coding block.

In the embodiments of the present disclosure, the PCM mode may be selected from at least one encoding mode including the PCM mode. The at least one encoding mode may include, but is not limited to, an intra-frame prediction mode.

Optionally, in one embodiment, different values of the syntax element of the intra-frame prediction mode of the first coding block may be used to indicate that the encoding mode of the first coding block is one of N types of intra-frame prediction modes or the PCM mode, where N is a positive integer. Correspondingly, when encoding with the intra-frame prediction mode, the PCM mode may be selected from the N types of intra-frame prediction modes and the PCM mode. The N types of intra-frame prediction modes and the PCM mode are also collectively referred to as “candidate encoding modes.”

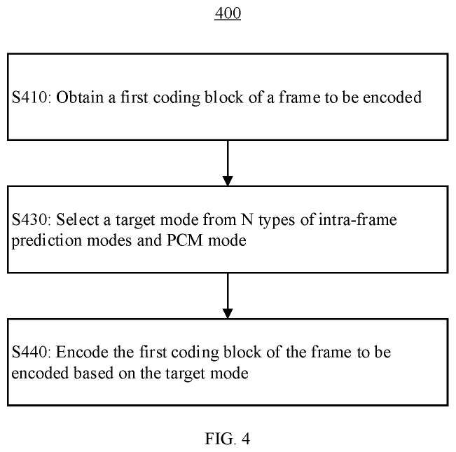

Another embodiment of the present disclosure in FIG. 4 provides another video encoding method 400. The method 400 includes S410 to S440.

At S410, a first coding block of a frame to be encoded is obtained.

At S430, a target mode is selected from the N types of intra-frame prediction modes and the PCM mode, where N is a positive integer.

At S440, the first coding block of the frame to be encoded is encoded based on the target mode.

In the video encoding method 400, the PCM mode is not selected during the block division. Instead, during selection of the encoding mode, the target mode is selected from the N types of intra-frame prediction modes and the PCM mode to encode the coding block. The flexibility and encoding/decoding efficiency of the video encoding/decoding may be improved.

In the video encoding method 400, S410 may be same as S310.

The target mode may be the PCM mode or any one of the N types of intra-frame prediction modes. The N types of intra-frame prediction modes may be prediction methods that remove the spatial redundant information of the current first coding block based on the image information of the current frame to be encoded as prediction data. That is, prediction 102, transformation 103, and quantization 104, and entropy encoding 105 may be performed on the first coding block, to form the code stream of the first coding block. In the PCM mode, the first coding block may be directly encoded and written into the code stream of the first coding block which may be stored or transmitted to the decoding end, without going through the aforementioned processes of prediction 102, transformation 103, quantization 104, and entropy encoding 105. Adoption of the PCM mode can realize lossless encoding, and skip the processes of prediction, transformation, quantization, and entropy encoding, to buffer the pressure on the time sequence of the encoding system.

In one embodiment, the target mode may be indicated in the syntax element of the intra-frame prediction mode of the first coding block. In some other embodiments, the target mode may be indicated in syntax elements other than the syntax element of the intra-frame prediction mode of the first coding block. The present disclosure has no limit on this.

Optionally, in the embodiments shown in FIG. 3 and FIG. 4, different values of the syntax element of the intra-frame prediction mode of the first coding block may indicate that the encoding mode of the first coding block is one of the N types of intra-frame prediction modes or the PCM mode. For example, the syntax element of the intra-frame prediction mode of the first coding block may be numbers, letters, symbols, or any combination thereof. Different values of the syntax elements may indicate different encoding modes, to transmit the encoding mode information of the first coding block.

Optionally, the different values of the syntax elements of the intra-frame prediction mode of the first coding block may be one of values in a continuous first numerical range, and the different values in the continuous first numerical range may be used to indicate different intra-frame prediction modes in the N types of intra-frame prediction modes and the PCM mode respectively. For example, in one embodiment, the continuous first numerical range is a˜b, where b−a≥N, and different numerical values in a˜b are used to indicate different intra-frame prediction modes or the PCM mode.

Optionally, the largest or smallest numerical value in the continuous first numerical range may be used to indicate the PCM mode. For example, in the continuous first numerical range a˜b, a or b is used to indicate the PCM mode.

In one embodiment, the continuous first numerical range may be 0 to M, where M is a positive integer larger than or equal to N. Correspondingly, different numerical values from 0 to N−1 may be used to indicate different intra-frame prediction modes in the N types of intra-frame prediction modes. N may be used to indicate the PCM mode, or 0 may be used to indicate the PCM mode.

In one embodiment, one coding block may include one luminance coding block. The first coding block may include a first luminance coding block. Specifically, the luminance coding block may be a luminance component of the image block and indicate the luminance information of the image block.

In some embodiments, the intra-frame prediction modes of the first luminance coding block may include 33 types: a DC prediction mode (Intra_Luma_DC), a planar prediction mode (Intra_Luma_Plane), a bilinear prediction mode (Intra_Luma_Bilinear), a vertical prediction mode (Intra_Luma_Vertical), a horizontal prediction mode (Intra_Luma_Horizontal), and 28 other angular prediction modes (Intra_Luma_Angular). As shown in Table 1, the different values of the syntax element (IntraLumaPredMode) of the intra-frame prediction mode of the first luminance coding block may be 0 to 33, where 0 to 32 are used to indicate 33 intra-frame prediction modes and 33 is used to indicate the PCM mode. By using the reserved intra-frame prediction mode syntax element 33 to indicate the PCM mode, using additional bits to indicate the PCM mode may be avoided. Therefore, the bit consumption may be reduced, and the flexibility and encoding efficiency of video coding and decoding may be improved.

TABLE 1

| IntraLumaPredMode | Intra-frame prediction mode |
|---|---|
| 0 | Intra_Luma_DC |
| 1 | Intra_Luma_Plane |
| 2 | Intra_Luma_Bilinear |
| 30~11 | Intra_Luma_Angular |
| 12 | Intra_Luma_Vertical |
| 13~23 | Intra_Luma_Angular |
| 24 | Intra_Luma_Horizontal |
| 25~32 | Intra_Luma_Angular |
| 33 | Intra_Luma_PCM |

Optionally, S330 where the first coding block in the frame to be encoded is encoded using the PCM mode may include: encoding the pixel values of the first coding block based on the PCM mode to form encoded pixel information of the first coding block; writing the encoded pixel information into the code stream of the first coding block; encoding the syntax element indicating the PCM mode in the syntax element of the intra-frame prediction mode of the first coding block and writing the encoded result into the code stream of the first coding block; and transmitting the information indicating that the first coding block is encoded using the PCM mode. For example, in the AVS3 standard, the PCM mode corresponds to the syntax element 33 of the intra-frame prediction modes. Correspondingly, the syntax element 33 of the intra-frame prediction mode is encoded and written into the code stream of the first coding block.

Optionally, S440 where the first coding block of the frame to be encoded is encoded based on the target mode may include: encoding the pixel values of the first coding block and the syntax element indicating the target mode, and writing the encoding results into the code stream of the first coding block. When the target mode is the PCM mode, S440 may be same as the S330.

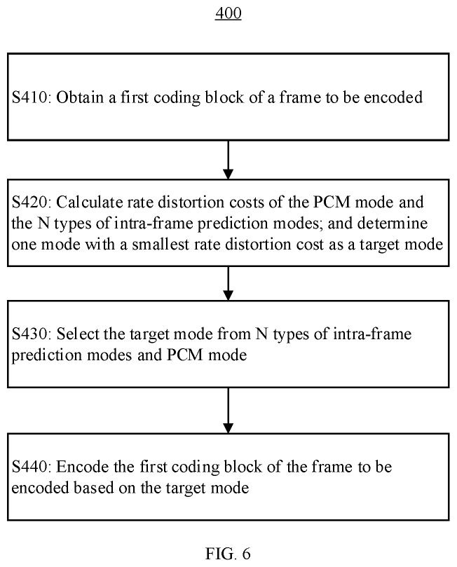

Optionally, in one embodiment shown in FIG. 6, before S430 where the target mode is selected from the PCM mode and the N types of intra-frame prediction modes, the video encoding method 400 further includes:

S420: calculating rate distortion costs (RD costs) of the PCM mode and the N types of intra-frame prediction modes; and when the rate distortion cost of one mode of the PCM mode and the N types of intra-frame prediction modes is smallest, selecting the one mode as the target mode.

A rate distortion optimization (RDO) technology may be used to calculate the rate distortion costs of the PCM mode and the N types of intra-frame prediction modes.

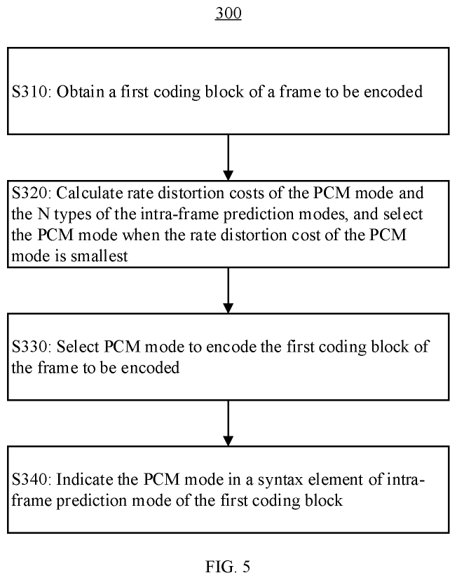

Optionally, in one embodiment shown in FIG. 5, before S330 where the PCM mode is selected from the PCM mode and the N types of intra-frame prediction modes, the video encoding method 300 further includes:

S320: calculating rate distortion costs (RD costs) of the PCM mode and the N types of intra-frame prediction modes; and when the rate distortion cost of the PCM mode is smallest, selecting the PCM mode.

When the target mode is the PCM mode, S320 may be same as S420, and description about S420 can be referred to for the detailed implementation.

For example, in the AVS3 standard, the RD costs of the 34 types of modes in Table 1 for the first coding block are calculated by traversal. When the RD cost of the PCM mode for the first coding block is smallest, the PCM mode with the smallest RD cost may be selected.

Optionally, in one embodiment, at S440, when the target mode is the PCM mode, the first coding block may be encoded using a fixed-length code encoding method. At S330, the PCM mode may be selected and the first coding block may be encoded using a fixed-length code encoding method based on the PCM mode.

Specifically, the original pixel values of the first coding block may be encoded using the fixed-length code encoding method and written into the code stream of the first coding block. The fixed-length code may be a code with the same code length for each codeword. After the original pixel values of the first coding block are encoded using the fixed-length code encoding method, the number of bits of the information value of various encoded pixels of the first coding block may be equal. The fixed-length code encoding method can realize the lossless transmission of the first coding block.

Optionally, the code length of the fixed-length code encoding may be equal to a bit depth (a number of bits) of the original pixel values of the first coding block.

Optionally, the original pixel values of the first coding block may be obtained, and the original pixel values of the first coding block may be directly assigned to the reconstructed pixel values of the first coding block to form the reconstruction block of the first coding block.

Optionally, the fixed-length code encoding method may be used to encode related syntax elements in the encoding process of the first coding block. For example, the syntax element of the intra-frame prediction mode of the first coding block may be encoded and written into the code stream of the first coding block using the fixed-length code encoding method.

A variable-length code encoding method may also be used to encode related syntax elements in the encoding process of the first coding block in other embodiment, which is not limited in the embodiments of the present disclosure.

Any coding block other than the first coding block in the frame to be encoded can be encoded by the above methods, and its encoding method may be the same as or different from the encoding method of the first coding block, which is not limited in the embodiments of the present disclosure.

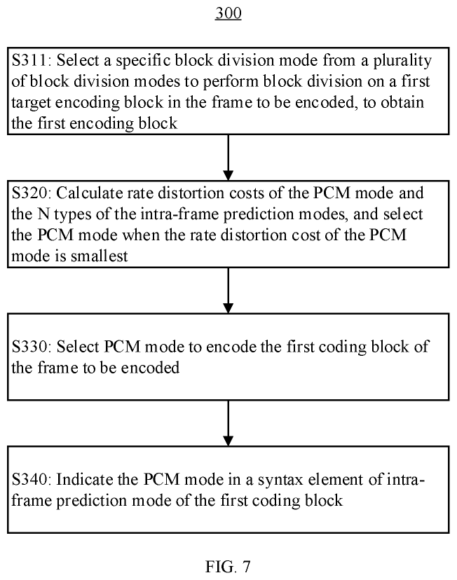

Optionally, in one embodiment shown in FIG. 7, S310 in the video encoding method 300 specifically includes:

S311: selecting a specific block division mode from a plurality of block division modes to perform block division on a first target coding block in the frame to be encoded, to obtain the first coding block.

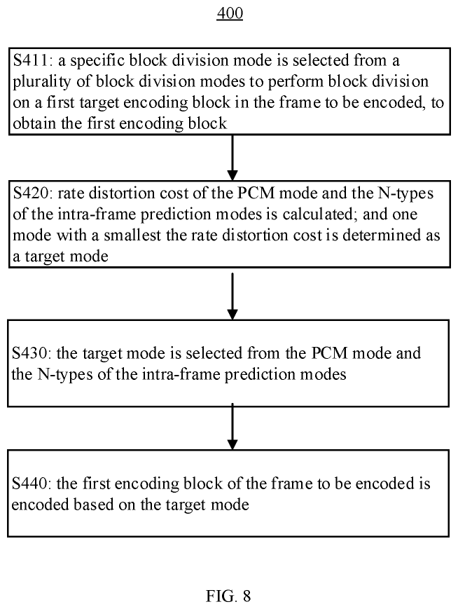

Optionally, in one embodiment shown in FIG. 8, 5410 in the video encoding method 400 may be same as S310, that is, S410 may include S411 which is same as S311.

The frame to be encoded may be divided to obtain the first target coding block and then the first target coding block may be further divided to obtain the first coding block. For example, the first target coding block may be an coding unit CU, and the first coding block may be a prediction unit PU.

The frame to be encoded may be divided into a plurality of target coding blocks that do not overlap with each other. Optionally, the frame to be encoded may be first divided into a plurality of largest target coding blocks that do not overlap with each other and have same size, and then the plurality of largest target coding blocks may be divided into the plurality of target coding blocks that do not overlap with each other first and have different size.

Optionally, a size of the first target coding block may be 64*64 pixels, 32*32 pixels, 16*16 pixels, or 8*8 pixels. The present disclosure has no limit on this.

Optionally, information of the division mode which is used to divide the frame to be encoded into the plurality of target coding blocks may be labeled in one related syntax element, and the syntax element about the division information may be encoded and written into the code stream of the first coding block.

In one embodiment, after the frame to be encoded is divided into the plurality of target coding blocks, the first target coding block may be any one target block of the plurality of target coding blocks, and the present disclosure has no limit on the position of the first target coding block in the plurality of target coding blocks and the size of the first target coding block.

The first target coding block may be divided into the plurality of coding blocks using any division mode such as iterative quadtree division. The present disclosure has no limit on this.

The size of the first coding block may be limited by the size of the first target coding block. When the first target coding block is divided by a specific block division method to obtain the plurality of coding blocks including the first coding block, the size of the plurality of coding blocks can be the same or different.

Optionally, in one embodiment, the specific block division modes may include dividing the first target coding block to obtain at least two first coding blocks.

For example, in some embodiments, when the coding unit CU is divided into a plurality of PUs, the PCM mode may be selected in units of PUs to encode the PUs. Therefore, the conditions for selecting the PCM mode may be less restrictive. Also, in the PCM mode, encoding may be performed in units of PUs, which has good encoding flexibility.

Optionally, in another embodiment, the specific block division mode may be no division, and the first target coding block may have the same size as the first coding block. For example, in the case of no division, the PCM mode may be used as an option for the first coding block for encoding.

FIG. 9 shows several exemplary manners of dividing the first target coding block into the plurality of coding blocks in various embodiments, where the size of the first target coding block is 2X*2Y pixels, and X and Y are positive integers larger than 2.

As shown in part (a) of FIG. 9, the first target coding block is divided into one coding block of 2X*2Y pixels. In this case, the division method is No_SPLIT;

As shown in part (b) of FIG. 9, the first target coding block is divided into four coding blocks of 2X*0.5Y pixels. In this case, the division method is HOR_tN;

As shown in part (c) of FIG. 9, the first target coding block is divided into four coding blocks of 0.5X*2Y pixels. In this case, the division method is VER_tN;

As shown in part (d) of FIG. 9, the first target coding block is divided into one coding block of 2X*0.5Y pixels and one coding block of 2X*1.5Y pixels. In this case, the division method is HOR_UP;

As shown in part (e) of FIG. 9, the first target coding block is divided into one coding block of 2X*1.5Y pixels and one coding block of 2X*0.5Y pixels. In this case, the division method is HOR_DOWN;

As shown in part (f) of FIG. 9, the first target coding block is divided into one coding block of 0.5X*2Y pixels and one coding block of 1.5X*2Y pixels. In this case, the division method is VER_LEFT;

As shown in part (g) of FIG. 9, the first target coding block is divided into one coding block of 1.5X*2Y pixels and a coding block of 0.5X*2Y pixels. In this case, the division method is VER_RIGHT;

Optionally, the block division information for dividing the first target code block into the plurality of coding blocks may be indicated in the relevant syntax element, and the syntax element of the block division information may be encoded and written into the code stream of the first code block.

In one embodiment, after the first target coding block is divided into the plurality of coding blocks, the first coding block may be any coding block of the plurality of coding blocks, and the present disclosure has no limit on the position of the first coding block in the plurality of coding blocks and the size of the first coding block.

In various embodiments of the present disclosure, the first target coding block may be divided into the plurality of coding blocks using division modes other than the division modes in FIG. 9. The present disclosure has no limit on this.

In the video encoding method 300 and the video encoding method 400 shown in FIG. 7 and FIG. 8 of the embodiments of the present disclosure, after a specific block division method is selected to perform block division on the first coding unit, the rate distortion costs of the various encoding modes may be calculated by traversal such that the target mode with the smallest rate distortion cost (which can be PCM mode) can be selected. Then the first coding block may be encoded and written into the code stream of the first coding block. The syntax element indicating the target mode (may be PCM mode) of the intra-frame prediction modes may be also encoded and written into the code stream of the first coding block, and the code stream of the first coding block may be stored or sent to the decoding end.

When the video encoding method 300 or the video encoding method 400 in the above embodiments is used, after the first target coding block is divided, calculation can be performed with respect to multiple encoding methods, and the optimal target mode (which can be the PCM mode) may be used for encoding the first coding block. The reserved syntax element may be used to indicate the PCM mode, to improve coding efficiency.

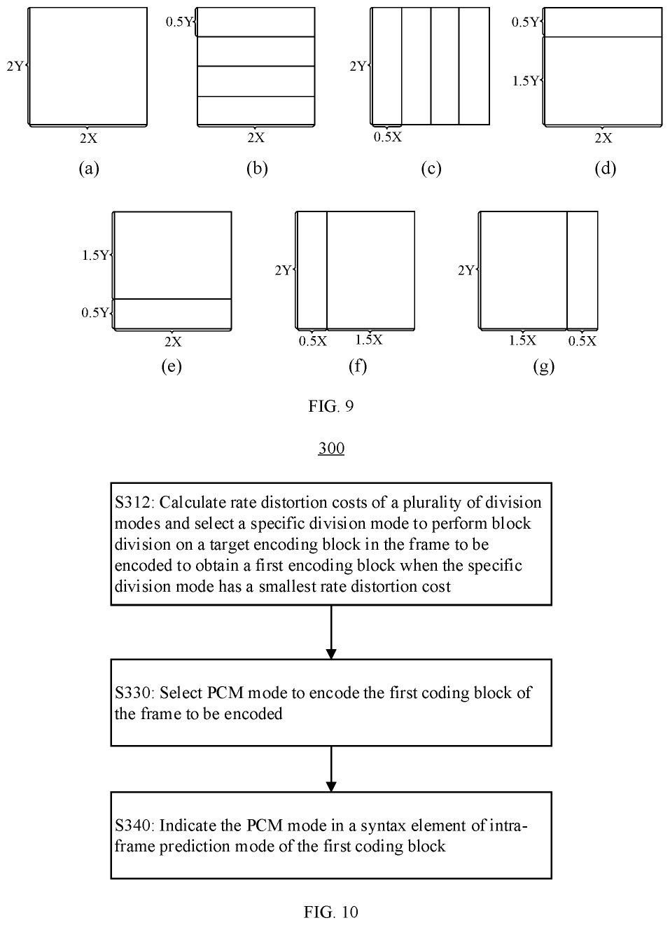

Optionally, in one embodiment shown in FIG. 10, S310 in the video encoding method 300 includes:

S312: calculating the rate distortion costs of a plurality of division modes, and selecting a specific division mode to perform the block division on the target coding block in the frame to be encoded to obtain the first coding block when the specific division mode has smallest rate distortion cost.

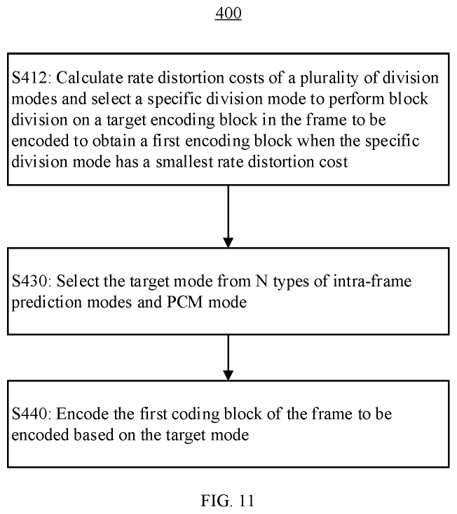

In one embodiment shown in FIG. 11, S410 in the video encoding method 400 is same as S310, that is, S410 includes S412 which is same as S312.

Specifically, encoding parameters related to the first target coding block may be set up, and the rate distortion costs of the plurality of division modes may be calculated by transversal, using the rate distortion optimization (RDO) method. One division mode of the plurality of division modes with the smallest rate distortion cost may be selected as the specific block division manner. For example, the plurality of division modes may include seven division modes in FIG. 8. The rate distortion costs of the seven division modes may be calculated by transversal, and one of the seven division modes with the smallest rate distortion cost may be selected as the specific block division mode.

For example, when the block division mode VER_tN in part (c) of FIG. 9 has the smallest rate distortion cost, the first coding block may be any one of four coding blocks of 0.5X*2Y, and the size of the first coding block may be ¼ of size of the first target coding block.

In another example, when the block division mode No_SPLIT in part (a) of FIG. 9 has the smallest rate distortion cost, the size of the first coding block may same as the size of the first target coding block.

Optionally, in one embodiment, when the specific block division mode is no division, the PCM mode may be selected to encode the target coding block when the target coding block is same as the first coding block. When the specific block division mode is division, the size of the target coding block may be different from the size of the first coding block, and the PCM mode may not be an option for encoding the first coding block. In some embodiments, the decoding end may determine whether the PCM mode is adopted according to the decoding results of the image block and there may be no need to wait for the results of the division of the image block. The hardware implementation may be easy.

In the video encoding method 300 and the video encoding method 400 shown in FIG. 10 and FIG. 11 of the embodiments of the present disclosure, the rate distortion costs of the plurality of division modes may be calculated by traversal such that one block division mode of the plurality of division modes with the smallest rate distortion cost can be selected as the specific block division mode. After using the specific block division mode to divide the first target coding block, the target mode (which can be the PCM mode) may be selected from the PCM mode and the N types of intra-frame prediction modes. Then the first coding block may be encoded and written into the code stream of the first coding block. The syntax element indicating the target mode (which can be the PCM mode) of the intra-frame prediction mode may be also encoded and written into the code stream of the first coding block, and the code stream of the first coding block may be stored or sent to the decoding end.

Using the video encoding method 300 or the video encoding method 400 in the above embodiments, the division mode may be optimized. Also, the target mode (which can be the PCM mode) may be used for encoding the first coding block and the reserved syntax element may be used to indicate the PCM mode, to improve coding efficiency.

Optionally, the first coding block may include a first luminance coding block. In one embodiment, the first coding block may be the first luminance coding block, and the frame to be encoded may further include a first chrominance coding block corresponding to the first luminance coding block.

Optionally, based on the video encoding method 300 or the video encoding method 400, another embodiment of the present disclosure also provides a video encoding method 500. The video encoding method may form a new video encoding method together with the video encoding method 300 or the video encoding method 400.

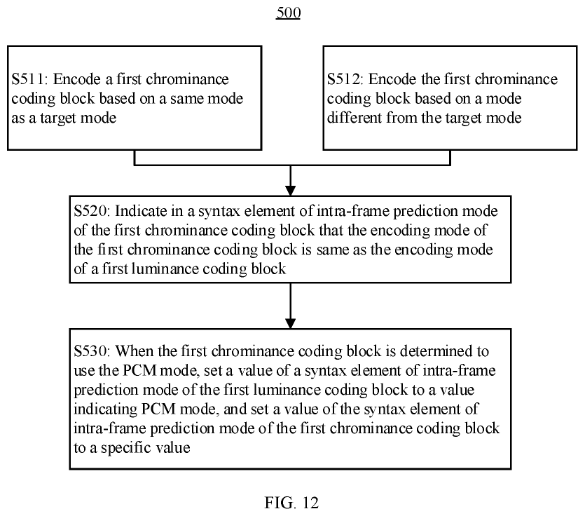

Optionally, based on the video encoding method 400, in one embodiment, the first chrominance coding block may be encoded based on the target mode of the first luminance coding block. As shown in FIG. 12, the video encoding method 500 includes:

S511: encoding the first chrominance coding block based on a mode same as the target mode; or

S512: encoding the first chrominance coding block based on a mode different from the target mode.

That is, the encoding mode of the first chrominance coding block may be the same as or different from the encoding mode of the first luminance block.

Specifically, in one embodiment, when the target mode adopted by the first luminance coding block is the PCM mode, the first chrominance coding block and the first luminance coding block may both be encoded in the PCM mode, or the first chrominance coding block may be encoded in a mode other than the PCM mode.

Specifically, in another embodiment, when the target mode adopted by the first luminance coding block is a first encoding mode other than the PCM mode, the first chrominance coding block may be encoded in the same first encoding mode at the same time as the first luminance coding block, or the first chrominance coding block may be encoded in another mode different from the first encoding mode. The other mode different from the first encoding mode may not include the PCM mode.

In the present disclosure, the first luminance coding block and the first chrominance coding block may be encoded in different encoding modes, in particular, when the first luminance coding block is encoded in the PCM mode and the first chrominance coding block may not be encoded in the PCM mode. Correspondingly, the encoding modes of the first luminance coding block and the first chrominance coding block can be decoupled, further improving the encoding flexibility and encoding efficiency.

In the present disclosure, the PCM mode may be selected to encode the first luminance coding block and the first chrominance coding block at the same time. Specifically, the first luminance coding block and the first chrominance coding block can both be directly encoded and written into the code stream, skipping the processes of prediction, transformation, quantization, and entropy encoding. The shared encoding mode of the first luminance coding block and the first chrominance coding block can be realized.

When the target mode in the video encoding method 500 is the PCM mode, based on the video encoding method 300, the video encoding method 500 may form a new video encoding method together with the video encoding method 300.

As shown in FIG. 12, in one embodiment, the video encoding method 500 further includes:

S520: indicating in the syntax element of the intra-frame prediction mode of the first chrominance coding block that the encoding mode of the first chrominance coding block is same as the encoding mode of the first luminance coding block.

In one embodiment, the different values of the syntax element of the intra-frame prediction mode of the first chrominance coding block may be used to indicate that the encoding mode of the first chrominance coding block is same as the encoding mode of the first luminance coding block or a specific encoding mode. For example, the syntax element of the intra-frame prediction mode of the first chrominance coding block may be numbers, letters, symbols, or any combination thereof. The different values of the syntax element may indicate different encoding modes for transmitting the encoding mode information of the first chrominance coding block.

Optionally, the different values of the syntax element of the intra-frame prediction mode of the first chrominance coding block may be one of values in a continuous second numerical range.

Specifically, a specific numerical value in the continuous second numerical range may be used to indicate that the encoding mode of the first chrominance coding block is the same as the encoding mode of the first luminance coding block.

For example, the continuous second numerical range may be c˜d. The specific numerical value may be c, being used to indicate that the encoding mode of the first chrominance coding block is the same as the encoding mode of the first luminance coding block.

Optionally, at least part of the numerical values in the continuous second numerical range other than the specific numerical value may be used to indicate that the encoding mode of the first chrominance coding block is a different chrominance intra-frame prediction mode respectively. For example, in the second numerical range c˜d, c+1˜d−1 may be used to indicate different chrominance intra-frame prediction modes, or c+1˜d may be all used to indicate different chrominance intra-frame prediction modes.

Similar to the intra-frame prediction mode of the first luminance coding block, the chrominance intra-frame prediction mode may include performing prediction 102, transformation 103, quantization 104 and entropy encoding 105 on the first chrominance coding block, to form the code stream of the first chrominance coding block. The PCM mode may be a process that directly encodes the first chrominance coding block and writes it into the code stream of the first coding block without going through the processes of prediction 102, transformation 103, quantization 104 and entropy encoding 105. Then the code stream of the first chrominance coding block may be stored or sent to the decoding end.

For example, in some embodiments, the intra-frame prediction modes of the first chrominance coding block may include a DC prediction mode (Intra_Chroma_DC), a TSCPM prediction mode (Intra_Chroma_TSCPM), a bilinear prediction mode (Intra_Chroma_Bilinear), a vertical prediction mode (Intra_Chroma_Vertical), or a horizontal prediction mode (Intra_Chroma_Horizontal). As shown in Table 2 below, the different values of the syntax element (IntraChromaPredMode) of the intra-frame prediction mode of the first chrominance coding block may be 0˜5. 0 may be the specific value, being used to indicate that the encoding mode of the first chrominance coding block is the same as the encoding mode of the first luminance coding block, that is, a DM (direct mode) mode.

In one embodiment, the syntax element 33 in the intra-frame prediction mode of the first luminance coding block may be used to indicate the PCM mode. When the first luminance coding block is one of at least two blocks obtained by dividing an upper-level coding block, the PCM mode may be not an option for the first luminance coding block, such that the syntax element of the intra-frame prediction mode of the first luminance coding block may not take the value 33, but a value from 0 to 32 (IntraLumaPredMode=0 to 32). When the syntax element of the intra-frame prediction mode of the first chrominance coding block corresponding to the first luminance coding block is a specific value (for example, 0), the intra-frame prediction mode of the first chrominance coding block may be the DM mode (Intra_Chroma_DM), and the specific value is used to indicate that the prediction modes of the first chrominance coding block and the first luminance coding block are the same and neither is the PCM mode. When the first luminance coding block is obtained by not dividing the upper-level coding block, the PCM mode can be used as an option of the first luminance coding block. When the syntax element of the intra-frame prediction mode of the first luminance coding block is 33 (IntraLumaPredMode=33), and the syntax element of the intra-frame prediction mode of the first chrominance coding block is a specific value (for example, 0), it may mean that the intra-frame prediction modes of the first luminance coding block and the first chrominance coding block are both PCM mode (Intra_Chroma_PCM). The syntax element with a specific value 0 may be used to indicate that the encoding modes of the first luminance coding block and the first chrominance coding block are same, and indicate the chrominance coding block is to be encoded in the PCM mode, which can avoid using extra bits to identify the PCM mode. The bit consumption may be reduced, and the flexibility and encoding efficiency of the video encoding or decoding may be improved.

TABLE 2

| IntraChromaPredMode | Intra-frame prediction mode |
|---|---|
| 0 | Intra_Chroma_DM |
| | (IntraLumaPredMode |
| | has a value different from 33) |
| 0 | Intra_Chroma_PCM |
| | (IntraLumaPredMode |
| | has a value of 33) |
| 1 | Intra_Chroma_DC |
| 2 | Intra_Chroma_Horizontal |
| 3 | Intra_Chroma_Vertical |
| 4 | Intra_Chroma_Bilinear |
| 5 | Intra_Chroma_TSCPM |

In some embodiments of the present disclosure, the syntax element of the intra-frame prediction mode of the first chrominance coding block may be used to indicate that the encoding modes of the first luminance coding block and the first chrominance coding block are same, such that the first chrominance coding block is to be encoded in the same PCM mode, which can avoid using extra bits to identify the PCM mode of the first chrominance coding block. The bit consumption may be reduced, and the flexibility and encoding efficiency of the video encoding or decoding may be improved.

Optionally, in one embodiment, based on the video encoding method 400 or the video encoding method 300, the encoding mode of the first luminance coding block may be determined according to the encoding mode of the first chrominance coding block, and then the encoding mode may be indicated in the syntax element of the intra-frame prediction mode.

As shown in FIG. 12, the video encoding method 500 further includes:

S530: when the first chrominance coding block is determined to use the PCM mode, setting the value of the syntax element of the intra-frame prediction mode of the first luminance coding block to the value indicating the PCM mode, and setting the value of the syntax element of the intra-frame prediction mode of the first chrominance coding block to the specific value.

For example, in one embodiment, when the first chrominance coding block is determined to use the PCM mode, the value of the syntax element of the intra-frame prediction mode of the first luminance coding block may be set to 33, and the value of the syntax element of the intra-frame prediction mode of the first chrominance coding block may be set to the specific value 0.

When the frame to be encoded is divided into a plurality of luminance coding blocks including the first luminance coding block and a plurality of chrominance coding blocks including the corresponding first chrominance coding block, other luminance coding blocks in the plurality of luminance coding blocks other than the first luminance coding block may have a prediction mode same as or different from the PCM mode used by the first luminance coding block, and other chrominance coding blocks in the plurality of chrominance coding blocks other than the first chrominance coding block may have a prediction mode same as or different from the encoding mode used by the first chrominance coding block. The present disclosure has no limit on this.

Optionally, besides the first target coding block, the frame to be encoded may further include a second target coding block and the second target coding block may include a second coding block. The second coding block may be one coding block of a plurality of coding blocks obtained by dividing the second target coding block.

Optionally, based on the video encoding method 400 or the video encoding method 300, the present disclosure also provides another video encoding method 600. The video encoding method 600 may form a new video encoding method together with the video encoding method 400 or the video encoding method 300, and/or the video encoding method 500.

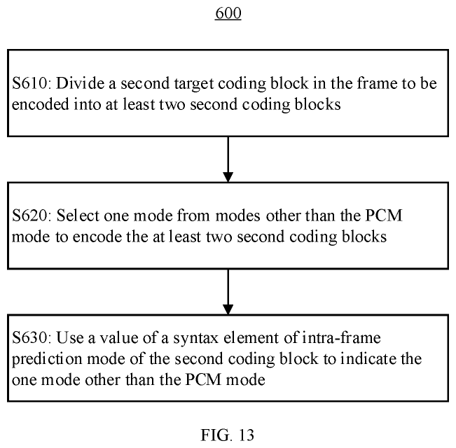

as shown in FIG. 13, the video encoding method 600 includes S610 and S620.

At S610, a second target coding block in the frame to be encoded is divided into at least two second coding blocks.

At S620, one mode is selected from modes other than the PCM mode to encode the at least two second coding blocks.

Optionally, at S610, any division mode such as the iterative quadtree division, may be used to divide the second target coding block in the frame to be encoded into the at least two second coding blocks, and the present disclosure has no limit on this. For example, in one embodiment, the division modes may be any one of (b)˜(g) in FIG. 9.

When the second target coding block in the frame to be encoded is divided into a plurality of coding blocks, one or more of the plurality of coding blocks of the second target coding block may be encoded by using one mode from modes other than the PCM mode. That is, one or more coding blocks may be encoded using a mode other than the PCM mode.

In one embodiment, the size of the second target coding block may be same as or different from the size of the first target coding block. The block division mode of the second target coding block may be same as or different from the block division mode of the first target coding block. The present disclosure has no limit on these.

Optionally, as shown in FIG. 13, the video encoding method 600 further includes:

S630: using a value of the syntax element of the intra-frame prediction mode of the second coding block to indicate the mode other than the PCM mode.

For example, the syntax element of the intra-frame prediction mode of the second coding block may be numbers, letters, symbols, or any combination thereof. The different values of the syntax element may indicate different encoding modes for transmitting information of the encoding mode of the second coding block.

Optionally, the numerical range of the syntax element of the intra-frame prediction mode of the second coding block may be within the numerical range of the syntax element of the intra-frame prediction mode of the first coding block.

For example, the first numerical range of the syntax element of the intra-frame prediction mode of the first coding block may be a˜b, and the numerical range of the syntax element of the intra-frame prediction mode of the second coding block may be a˜b−1 or a−1˜b.

In one embodiment, the first numerical range of the syntax element of the intra-frame prediction mode of the first coding block may be 0˜M, and the value of the syntax element of the intra-frame prediction mode of the second coding block may be a value from 0 to M−1 where M is a positive integer. Optionally, the syntax element M of the syntax element of the intra-frame prediction mode of the first coding block may be used to indicate the PCM mode.

In this embodiment of the present disclosure, different target coding units may be divided in different ways. When the second target coding block is divided into the plurality of coding blocks, the second coding blocks in the second target coding unit may not adopt the PCM mode for encoding. Therefore, the syntax element of the intra-frame prediction mode of the second coding block may not indicate the value of the PCM mode, thereby saving the bit consumption of the syntax element and improving the coding efficiency.

Optionally, in one embodiment, when the specific block division mode is no division, the target coding block may be encoded based on the PCM mode; when the specific block division mode is division, the first coding block can also be encoded in PCM mode, which improves the flexibility of video encoding.

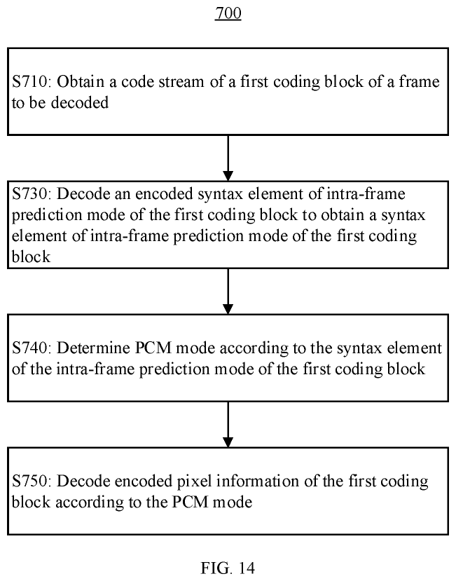

Various embodiments of the present disclosure in FIG. 14 to FIG. 19 also provide video decoding methods.

One embodiment in FIG. 14 provides a video decoding method 700 corresponding to the video encoding method 300. That is, the first coding block in the frame to be encoded is encoded using the video encoding method 300 to form the code stream of the first coding block, and the code stream of the first coding block is decoded using the video decoding method 700. The code stream of the first coding block includes encoded syntax elements of the intra-frame prediction mode of the first coding block and encoded pixel information of the first coding block.

As shown in FIG. 14, the video decoding method 700 include:

S710: obtaining the code stream of the first coding block of the frame to be decoded;

S730: decoding the encoded syntax element of the intra-frame prediction mode of the first coding block to obtain the syntax element of the intra-frame prediction mode of the first coding block;

S740: determining the PCM mode according to the syntax element of the intra-frame prediction mode of the first coding block;

S750: decoding the encoded pixel information of the first coding block according to the PCM mode.

Optionally, at S710, the code stream of the first coding block may be obtained from a memory or from the encoding end. The code stream of the first coding block may be generated by any embodiments of the video encoding method 300. The syntax element of the intra-frame prediction mode of the first coding block may be encoded to obtain the encoded syntax element of the intra-frame prediction mode of the first coding block, and the pixel values of the first coding block may be encoded to obtain the encoded pixel information of the first coding block.

Specifically, at S740, it may be determined according to the syntax element of the intra-frame prediction mode of the first coding block that the pixel values of the first coding block are encoded in the PCM mode during encoding, that is, the encoded pixel information of the first coding block is generated by encoding the pixel values of the first coding block in the PCM mode.

For example, in the AVS3 standard, the encode syntax element of the intra-frame prediction mode of the first coding block may be decoded to obtain the syntax element of the intra-frame prediction mode of the first coding block as 33, and it may be determined according to the syntax element information that the pixel values of the first coding block are encoded in the PCM mode.

Specifically, at S750, based on the PCM mode, the encoded pixel information of the first coding block may be directly decoded without processes including entropy decoding, inverse quantization, and inverse transformation.

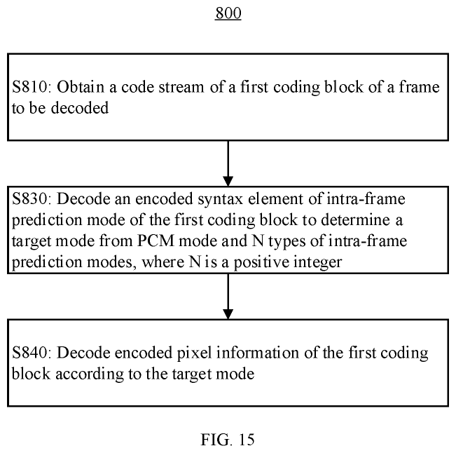

One embodiment in FIG. 15 provides another video decoding method 800 corresponding to the video encoding method 400. That is, the first coding block in the frame to be encoded is encoded using the video encoding method 400 to form the code stream of the first coding block, and the code stream of the first coding block is decoded using the video decoding method 800.

As shown in FIG. 15, the video decoding method 800 includes:

S810: obtaining the code stream of the first coding block of the frame to be decoded;

S830: decoding the encoded syntax element of the intra-frame prediction mode of the first coding block to determine a target mode from the PCM mode and N types of intra-frame prediction modes, where N is a positive integer;

S840: decoding the encoded pixel information of the first coding block according to the target mode.

S810 in this embodiment may be the same as S710.

The target mode is consistent with the target mode in the video encoding method 400. For related descriptions, reference can be made to the video encoding method 400, which will not be repeated here.

Specifically, at S830, it may be determined according to the syntax element of the intra-frame prediction mode of the first coding block that the pixel values of the first coding block are encoded in the target mode during encoding, that is, the encoded pixel information of the first coding block is generated by encoding the pixel values of the first coding block in the target mode.

For example, the encoded syntax element of the intra-frame prediction mode of the first coding block may be decoded to obtain that the syntax element of the intra-frame prediction mode of the first coding block is 0, and it may be determined according to the syntax element information that the pixel values of the first coding block are encoded in the DC prediction mode.

Specifically, at S840, based on the target mode, the pixel information of the first coding block may be decoded. When the target mode is one of the N types of the intra-frame prediction modes, decoding processes such as entropy decoding, inverse quantization, inverse transformation, or prediction, may be performed on the pixel information of the first coding block. When the target mode is the PCM mode, S840 may be the same as S750.

Optionally, corresponding to the video encoding method 300 and the video encoding method 400, in the video decoding method 700 and the video decoding method 800, the different values of the syntax element of the intra-frame prediction mode of the first coding block may be used to indicate the encoding mode of the first coding block is different one of the N types of intra-frame prediction modes or the PCM mode, where N is a positive integer.

Optionally, the different values of the syntax element of the intra-frame prediction mode of the first coding block may be one of values in the continuous first numerical range, and the different values in the continuous first numerical range may be used to respectively indicate one of the different intra-frame prediction modes among the N types of intra-frame prediction modes or the PCM mode.

Optionally, the largest or smallest numerical value in the continuous first numerical range may be used to indicate the PCM mode.

Optionally, the continuous first numerical range may be 0 to M, where M is a positive integer larger than or equal to N;

Different values from 0 to N−1 may be used to indicate different intra-frame prediction modes among the N types of intra-frame prediction modes. N may be used to indicate the PCM mode, or 0 may be used to indicate the PCM mode.

For example, when the first coding block is the first luminance coding block, the encoded syntax element of the intra-frame prediction mode of the first luminance coding block may be decoded to obtain that the syntax element of the intra-frame prediction mode of the first luminance coding block can be any value from 0 to 33, where each value corresponds to an encoding mode and the value 33 corresponds to the PCM mode. Specifically, the encoding modes corresponding to different values are shown in Table 1 and related descriptions, which will not be repeated here.

In one embodiment, at S750, or at S840 when the target mode at S840 is the PCM mode, the encoded pixel information of the first coding block may be directed read out based on the PCM mode, and the encoded pixel information of the first coding block may be the pixel values of the first coding block.

In another embodiment, at S750, or at S840 when the target mode at S840 is the PCM mode, the encoded pixel information of the first coding block may be decoded according to a fixed-length code decoding method, based on the PCM mode.

Specifically, the fixed-length code decoding method may be used to decode the encoded pixel information of the first coding block to obtain the pixel values of the first coding block. The fixed-length code decoding method may correspond to the fixed-length code encoding method in the video encoding method 300 or the video encoding method 400. After the fixed-length code decoding method is used to decode the encoded pixel information of the first coding block, the number of bits in each pixel value may be equal.

Optionally, the code length of the fixed-length code decoding method may be equal to a bit depth (a number of bits) of the pixel values of the first coding block.

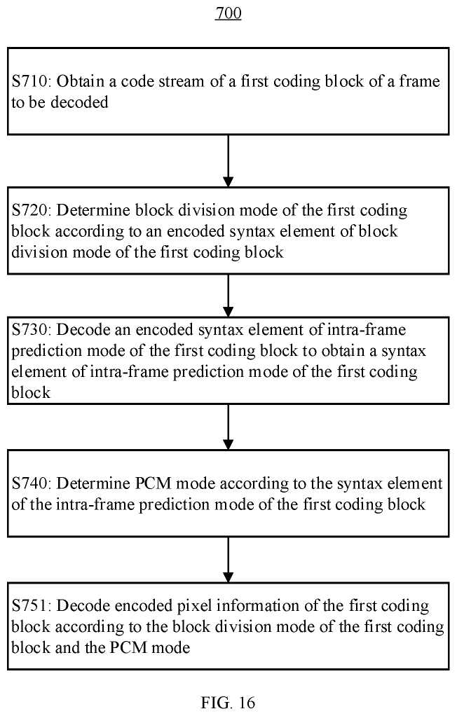

Optionally, in one embodiment, the code stream of the first coding block may further include an encoded syntax element of the block division mode of the first coding block. As shown in FIG. 16, in some embodiments, the video decoding method 700 further include:

S720: determining the block division mode of the first coding block according to the encoded syntax element of the block division mode of the first coding block.

S750 may specifically include: S751: decoding the encoded pixel information of the first coding block according to the block division mode of the first coding block and the PCM mode.

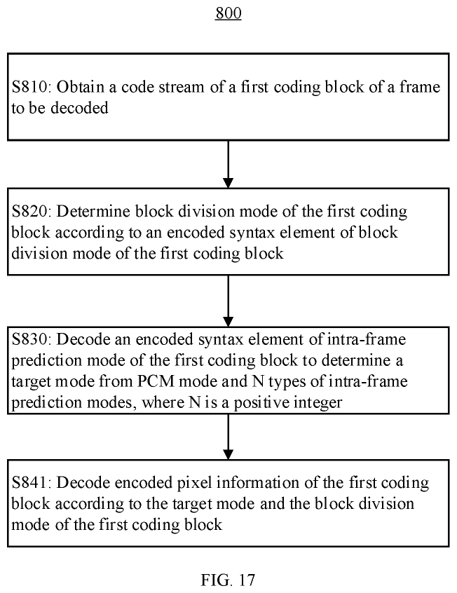

In one embodiment, as shown in FIG. 17, the video decoding method 800 further includes S820 and S820 may be the same as S720. S840 may specifically include: S841: decoding the encoded pixel information of the first coding block according to the block division mode of the first coding block and the target mode.

Specifically, in the video encoding method 300 and the video encoding method 400, the first coding block may be one coding block obtained after block division of the frame to be coded. During the encoding process, the corresponding block division information may be identified by a corresponding syntax element, and the syntax elements of the block division mode of the first coding block may be encoded and written into the code stream of the first coding block.

Specifically, at S720 and S820, the block division mode of the first coding block may be determined according to the syntax element of the block division mode of the first coding block, to determine a position relationship of the first coding block in the first coding unit in which the first coding block is located and size information of the first coding block.

Optionally, in one embodiment, the block division mode of the first coding block may be any one of the block division modes in FIG. 9.

Optionally, the block division mode of the first coding block may be no division. When the block division mode of the first coding block may be no division, the encoding mode of the first coding block may be the PCM mode.

Optionally, in one embodiment, when the block division mode of the first coding block is division, it may be determined that the encoding mode of the first coding block cannot be the PCM mode.

The code stream of any coding blocks except the code stream of the first coding block in the frame to be decoded can be decoded by the above method, and the decoding method can be the same as or different from that of the code stream of the first coded block. The present disclosure has no limit on this.

Optionally, the code stream of the first coding block may include the code stream of the first luminance coding block. In a possible implementation, the code stream of the first coding block may be the code stream of the first luminance coding block, and the frame to be decoded may further include the code stream of the first chrominance coding block corresponding to the first luminance coding block.

Optionally, based on the video decoding method 700 or the video decoding method 800, the present disclosure also provides a video decoding method 900. The video decoding method 900 corresponds to the video encoding method 500. The video decoding method 900 may be combined with the video decoding method 700 or the video decoding method 800 together to form a new video decoding method.

Optionally, based on the video decoding method 800, in one embodiment, the encoded pixel information of the first chrominance coding block may be decoded based on the encoding mode of the first luminance coding block.

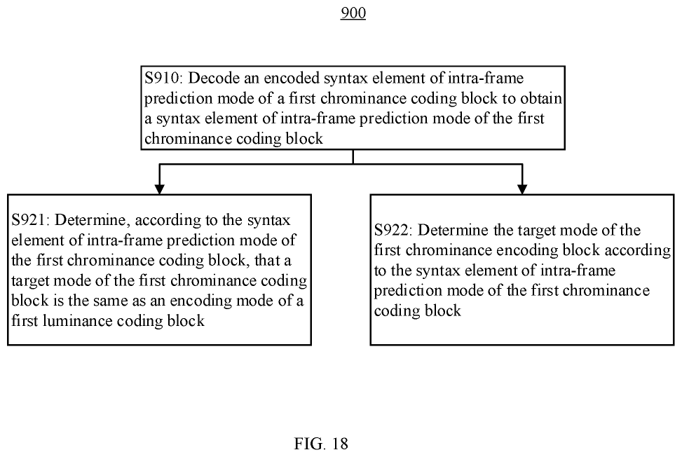

As shown in FIG. 18, the video decoding method 900 includes:

S910: decoding the encoded syntax element of the intra-frame prediction mode of the first chrominance coding block to obtain the syntax element of the intra-frame prediction mode of the first chrominance coding block;

S921: determining, according to the syntax element of the intra-frame prediction mode of the first chrominance coding block, that the target mode of the first chrominance coding block is the same as the encoding mode of the first luminance coding block;

Or, S922: determining the target mode of the first chrominance coding block according to the syntax element of the intra-frame prediction mode of the first chrominance coding block.

Optionally, the target mode may be the PCM mode.

When the target mode is the PCM mode, based on the video decoding method 700, the video decoding method 900 may be combined with the video decoding method 700 to form a new video encoding method.

Optionally, the target mode of the first chrominance coding block may also be another mode other than the PCM mode, for example, one of the chrominance intra-frame prediction modes.

Optionally, the different values of the syntax element of the intra-frame prediction mode of the first chrominance coding block may be one value in a continuous second numerical range.

A specific numerical value in the continuous second numerical range may be used to indicate that the encoding mode of the first chrominance coding block is the same as the encoding mode of the first luminance coding block.

Optionally, at least part of the numerical values in the continuous second numerical range other than the specific numerical value may be used to respectively indicate that the encoding mode of the first chrominance coding block is a different chrominance intra-frame prediction mode.

Specifically, in one embodiment, when it is determined that the encoding mode of the first luminance coding block is the PCM mode, and the syntax element of the first chrominance coding block is the specific value, it may be determined that the encoding mode of the first chrominance coding block is the PCM mode.

For example, the encoded syntax element of the intra-frame prediction mode of the first luminance coding block may be decoded to obtain that the encoding mode of the first luminance coding block is the PCM mode. In this case, the encoded syntax element of the intra-frame prediction mode of the first chrominance coding block may be decoded to obtain that the syntax element of the first chrominance coding block is a specific value of 0, to indicate that the encoding mode of the first chrominance coding block is the same as the encoding mode of the first luminance coding block and both are the PCM modes. For another example, when the encoded syntax element of the intra-frame prediction mode of the first chrominance coding block is decoded to obtain that the syntax element of the first chrominance coding block is value 1, the encoding mode of the first chrominance coding block may be determined to be the chrominance DC prediction mode. Specifically, the encoding modes corresponding to different values of the encoded syntax elements of the intra-frame prediction mode of the first chrominance coding block are shown in Table 2 and related descriptions, which will not be repeated here.

In the present disclosure, the encoding mode of the first chrominance coding block same as the encoding mode of the first luminance coding block may be indicated in the syntax element of the intra-frame prediction mode of the first chrominance coding block, such that the first chrominance coding block can be decoded using the same PCM mode without occupying an extra bit for indicating the PCM mode of the first chrominance coding block. The coding efficiency may be improved.

Optionally, the frame to be decoded may further include a code stream of a second coding block. The code stream of the second coding block may include an encoded syntax element of the block division mode of the second coding block, an encoded syntax element of the intra-frame prediction mode of the second coding block, and the encoded pixel information of the second coding block.

Optionally, based on the video decoding method 700 or the video decoding method 800, the present disclosure also provides a video decoding method 1000. The video decoding method 1000 corresponds to the video encoding method 600. The video decoding method 1000 may be combined with the video decoding method 700 or the video decoding method 800, and/or the video decoding method 900, together to form a new video decoding method.

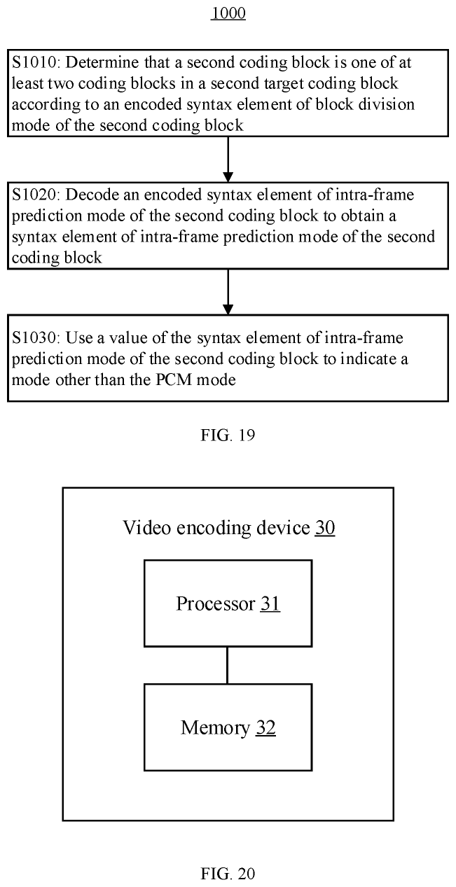

As shown in FIG. 19, the video decoding method 1000 includes:

S1010: determining that the second coding block is one of at least two coding blocks in a second target coding block according to the encoded syntax element of the block division mode of the second coding block;

S1020: decoding the encoded syntax element of the intra-frame prediction mode of the second coding block to obtain the syntax element of the intra-frame prediction mode of the second coding block.

Optionally, at S1010, the block division mode determined based on the encoded syntax element of the block division mode of the second coding block may be any block division mode where the second target coding block is divided into a plurality of coding blocks.

For example, in the AVS3 standard, the block division mode may be any one of (b)˜(g) in FIG. 9. The second coding block may be any one of the plurality of coding blocks in the second target coding block.

Optionally, as shown in FIG. 19, the video decoding method 1000 further includes:

S1030: using the value of the syntax element of the intra-frame prediction mode of the second coding block to indicate a mode other than the PCM mode.

Optionally, the value of the syntax element of the intra-frame prediction mode of the first coding block may be a value from 0 to M.

The value of the syntax element of the intra-frame prediction mode of the second coding block may be a value from 0 to M−1; where M is a positive integer.

Optionally, when the syntax element of the intra-frame prediction mode takes a value of M, it may be used to indicate the PCM mode.

The present disclosure also provides video encoding devices. The embodiments of the video encoding devices correspond to the embodiments of the video encoding methods, and similar description are shown in the embodiments of the video encoding methods.

As shown in FIG. 20, one embodiment of the present disclosure provides a video encoding device 30 corresponding to the video decoding method 300. Optionally, the video encoding device 30 may also correspond to new video encoding methods formed by combining the video decoding method 300 and the video encoding method 500 and/or the video encoding method 600.

As shown in FIG. 20, the video encoding device 30 includes a processor 31 and a memory 32.

The memory 32 is configured to store a program. The processor 31 is configured to execute the program stored in the memory 32, to execute: selecting the PCM mode to encode a first coding block in a frame to be encoded, and indicating the PCM mode in a syntax element of an intra-frame prediction mode of the first coding block.

Optionally, in one embodiment, the processor 31 may be a processor or controller in an electronic device where the video encoding device 30 is located.

Optionally, different values of the syntax element of the intra-frame prediction mode of the first coding block may indicate that the encoding mode of the first coding block is one of N types of intra-frame prediction modes or the PCM mode. Optionally, the different values of the syntax elements of the intra-frame prediction mode of the first coding block may be one of the values in a continuous first numerical range, and the different values in the continuous first numerical range may be used to respectively indicate different intra-frame prediction modes among the N types of intra-frame prediction modes and the PCM mode. In one embodiment, the continuous first numerical range may be 0 to M, where M is a positive integer larger than or equal to N. Correspondingly, different numerical values from 0 to N−1 may be used to indicate different intra-frame prediction modes in the N types of intra-frame prediction modes, N may be used to indicate the PCM mode, or 0 may be used to indicate the PCM mode.

Optionally, the processor 31 may be configured to: select the PCM mode from the N types of intra-frame prediction modes and the PCM mode to encode the first coding block.

Optionally, before selecting the PCM mode from the N types of intra-frame prediction modes and the PCM mode, the processor 31 may be configured to: calculate rate distortion costs (RD costs) of the PCM mode and the N types of intra-frame prediction modes; and when the rate distortion cost of the PCM mode is smallest, select the PCM mode.

Optionally, the processor 31 may be configured to: encode the first coding block using a fixed-length code encoding method according to the PCM mode.

Optionally, the processor 31 may be configured to: select a specific block division mode from a plurality of block division modes to perform block division on a first target coding block in the frame to be encoded, to obtain the first coding block.

Optionally, before selecting the specific block division modes from a plurality of block division modes, the processor 31 may be configured to: calculate the rate distortion costs of a plurality of division modes, and select the specific division mode when the specific division mode has smallest rate distortion cost. Optionally, the specific division mode may be no division.

Optionally, the first coding block may include a first luminance coding block, and the frame to be encoded may further include a first chrominance coding block corresponding to the first luminance coding block. The processor 31 may be further configured to: indicate in the syntax element of the intra-frame prediction mode of the first chrominance coding block that the encoding mode of the first chrominance coding block is same as the encoding mode of the first luminance coding block. Optionally, the different values of the syntax element of the intra-frame prediction mode of the first chrominance coding block may be one of values in a continuous second numerical range. A specific numerical value in the continuous second numerical range may be used to indicate that the encoding mode of the first chrominance coding block is the same as the encoding mode of the first luminance coding block. Optionally, at least part of the numerical values in the continuous second numerical range other than the specific numerical value may be used to respectively indicate that the encoding mode of the first chrominance coding block is a different chrominance intra-frame prediction mode respectively.

Optionally, the first coding block may include a first luminance coding block, and the frame to be encoded may further include a first chrominance coding block corresponding to the first luminance coding block. The processor 31 may be further configured to: select the PCM mode to encode the first luminance coding block. The processor 31 may be further configured to: select the PCM mode to encode the first chrominance coding block.

Optionally, the processor 31 may be further configured to: when the first chrominance coding block is determined to use the PCM mode, set the value of the syntax element of the intra-frame prediction mode of the first luminance coding block to the value of the PCM mode, and set the value of the syntax element of the intra-frame prediction mode of the first chrominance coding block to the specific value.

Optionally, the first coding block may include a first luminance coding block, and the frame to be encoded may further include a first chrominance coding block corresponding to the first luminance coding block. The processor 31 may be further configured to: select the PCM mode to encode the first luminance coding block. The processor 31 may be further configured to: select a mode other than the PCM mode to encode the first chrominance coding block.

Optionally, the processor 31 may be further configured to: divide a second target coding block to at least two second coding blocks, and indicate a mode other than the PCM mode in a syntax element of the intra-frame prediction mode of the at least two second coding blocks.

The value of the syntax element of the intra-frame prediction mode of the first coding block may be a value from 0 to M, and the value of the syntax element of the intra-frame prediction mode of the second coding block may be a value from 0 to M−1, where M is a positive integer.

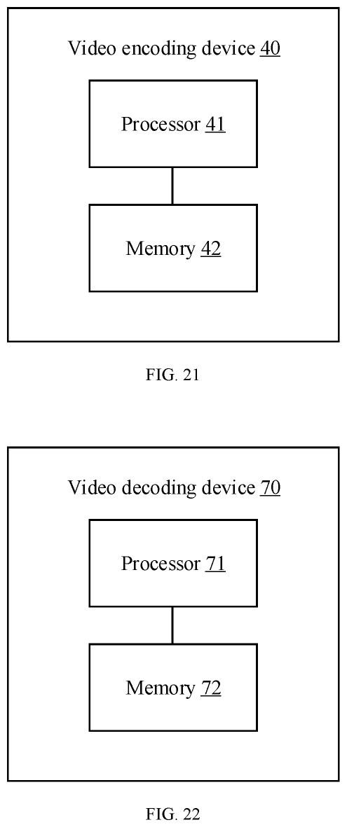

As shown in FIG. 21, one embodiment of the present disclosure provides a video encoding device 40 corresponding to the video decoding method 400. Optionally, the video encoding device 40 may also correspond to new video encoding methods formed by combining the video decoding method 400 and the video encoding method 500 and/or the video encoding method 600.

As shown in FIG. 21, the video encoding device 40 includes a processor 41 and a memory 42.

The memory 42 is configured to store a program. The processor 41 is configured to execute the program stored in the memory 42, to execute: obtaining a first coding block of the frame to be encoded; selecting a target mode from the PCM mode and N types of intra-frame prediction mode; and encoding the first coding block in the frame to be encoded base don the target mode. N is a positive integer.

Optionally, the processor 41 may be further configured to indicate the target mode in a syntax element of an intra-frame prediction mode of the first coding block.

Optionally, different values of the syntax element of the intra-frame prediction mode of the first coding block may indicate that the encoding mode of the first coding block is one of the N types of intra-frame prediction modes or the PCM mode.

Optionally, the different values of the syntax elements of the intra-frame prediction mode of the first coding block may be one of the values in a continuous first numerical range, and the different values in the continuous first numerical range may be used to respectively indicate different intra-frame prediction modes among the N types of intra-frame prediction modes and the PCM mode.

Optionally, the largest or smallest numerical value in the continuous first numerical range may be used to indicate the PCM mode.

In one embodiment, the continuous first numerical range may be 0 to M, where M is a positive integer larger than or equal to N.

Different numerical values from 0 to N−1 may be used to indicate different intra-frame prediction modes in the N types of intra-frame prediction modes. N may be used to indicate the PCM mode, or 0 may be used to indicate the PCM mode.

Optionally, when the target mode is one of the N types of intra-frame prediction modes, the processor 41 may be configured to perform prediction, transformation, quantization, or entropy encoding on the first coding block based on the target mode.

Optionally, when the target mode is the PCM mode, the processor 41 may be configured to use the fixed-length code encoding method to encode the first coding block based on the PCM mode.

Optionally, before selecting the target mode from the N types of intra-frame prediction modes and the PCM mode, the processor 41 may be configured to: calculate rate distortion costs (RD costs) of the PCM mode and the N types of intra-frame prediction modes; and when the rate distortion cost of the target mode is smallest, select the target mode.

Optionally, the processor 41 may be further configured to: select a specific block division mode from a plurality of block division modes to perform block division on a first target coding block in the frame to be encoded, to obtain the first coding block.

Optionally, the processor 41 may be further configured to: select the PCM mode from the N types of intra-frame prediction modes and the PCM mode as the target mode.

Optionally, before selecting the specific block division modes from a plurality of block division modes, the processor 31 may be configured to: calculate the rate distortion costs of a plurality of division modes, and select the specific division mode when the specific division mode has smallest rate distortion cost.

Optionally, the specific division mode may be no division.

Optionally, the processor 41 may be further configured to: divide a second target coding block to at least two second coding blocks, and select a mode from modes other than the PCM mode to encode the at least two second coding blocks.

Optionally, the value of the syntax element of the intra-frame prediction mode of the at least two second coding blocks may be used to indicate the mode other than the PCM mode.

The value of the syntax element of the intra-frame prediction mode of the first coding block may be a value from 0 to M, and the value of the syntax element of the intra-frame prediction mode of the second coding block may be a value from 0 to M−1, where M is a positive integer.

Optionally, the syntax element of the intra-frame prediction mode with a value of M may be used to indicate the PCM mode.

Optionally, the first coding block may include a first luminance coding block, and the frame to be encoded may further include a first chrominance coding block corresponding to the first luminance coding block.

The processor 41 may be further configured to: indicate in the syntax element of the intra-frame prediction mode of the first chrominance coding block that the encoding mode of the first chrominance coding block is same as the encoding mode of the first luminance coding block.

Optionally, the different values of the syntax element of the intra-frame prediction mode of the first chrominance coding block may be one of values in a continuous second numerical range.

A specific numerical value in the continuous second numerical range may be used to indicate that the encoding mode of the first chrominance coding block is the same as the encoding mode of the first luminance coding block.

Optionally, at least part of the numerical values in the continuous second numerical range other than the specific numerical value may be used to respectively indicate that the encoding mode of the first chrominance coding block is a different chrominance intra-frame prediction mode respectively.

Optionally, the first coding block may include a first luminance coding block, and the frame to be encoded may further include a first chrominance coding block corresponding to the first luminance coding block.

The processor 41 may be further configured to: select the target mode to encode the first luminance coding block. The processor 41 may be further configured to: select a mode same as the target mode to encode the first chrominance coding block.

Optionally, the processor 41 may be further configured to: when the first chrominance coding block is determined to use the PCM mode, set the value of the syntax element of the intra-frame prediction mode of the first luminance coding block to the value of the PCM mode, and set the value of the syntax element of the intra-frame prediction mode of the first chrominance coding block to the specific value.

Optionally, the first coding block may include a first luminance coding block, and the frame to be encoded may further include a first chrominance coding block corresponding to the first luminance coding block. The processor 41 may be further configured to: select the target mode to encode the first luminance coding block. The processor 31 may be further configured to: select a mode different from the target mode to encode the first chrominance coding block.

The present disclosure also provides video decoding devices. The embodiments of the video decoding devices correspond to the embodiments of the video decoding methods, and similar description are shown in the embodiments of the video decoding methods.

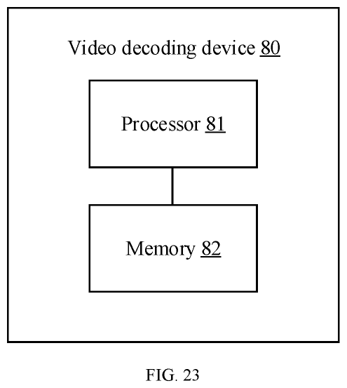

As shown in FIG. 22, one embodiment of the present disclosure provides a video decoding device 70 corresponding to the video decoding method 700. Optionally, the video decoding device 70 may also correspond to new video decoding methods formed by combining the video decoding method 700 and the video decoding method 900 and/or the video decoding method 1000.

As shown in FIG. 22, the video encoding device 70 includes a processor 71 and a memory 72.

The memory 72 is configured to store a program. The processor 71 is configured to execute the program stored in the memory 72, to execute: obtaining a code stream of a first coding block in a frame to be decoded, where the code stream of the first coding block includes encoded syntax elements of the intra-frame prediction mode of the first coding block and encoded pixel information of the first coding block; decoding the encoded syntax element of the intra-frame prediction mode of the first coding block to obtain the syntax elements of the intra-frame prediction mode of the first coding block; determining the PCM mode according to the syntax elements of the intra-frame prediction mode of the first coding block; and decoding the encoded pixel information of the first coding block according to the PCM mode.

Optionally, the different values of the syntax element of the intra-frame prediction mode of the first coding block may be used to indicate the encoding mode of the first coding block is one of the N types of intra-frame prediction modes or the PCM mode, where N is a positive integer.

Optionally, the different values of the syntax element of the intra-frame prediction mode of the first coding block may be one of values in the continuous first numerical range, and the different values in the continuous first numerical range may be used to respectively indicate one of the different intra-frame prediction modes among the N types of intra-frame prediction modes or the PCM mode.

Optionally, the largest or smallest numerical value in the continuous first numerical range may be used to indicate the PCM mode.

In one embodiment, the continuous first numerical range may be 0 to M, where M is a positive integer larger than or equal to N.

Correspondingly, different numerical values from 0 to N−1 may be used to indicate different intra-frame prediction modes in the N types of intra-frame prediction modes, N may be used to indicate the PCM mode, or 0 may be used to indicate the PCM mode.

Optionally, the processor 71 may be configured to: use the fixed-length code decoding method to decode the encoded pixel information of the first coding block according to the PCM mode.

Optionally, the code stream of the first coding block may further include a syntax element of the block division mode of the first coding block.

The processor 71 may be configured to: determine the block division mode of the first coding block according to the syntax element of the block division mode of the first coding block; and decode the encoded pixel information of the first coding block according to the PCM mode and the block division mode of the first coding block.

Optionally, the block division mode of the first coding block may be no division.

Optionally, the code stream of the first coding block may include a code stream of a first luminance coding block.

The frame to be decoded may further include a code stream of a first chrominance coding block corresponding to the first luminance coding block. The code stream of the first chrominance coding block may include an encoded syntax element of the intra-frame prediction mode of the first chrominance coding block and encoded pixel information of the first chrominance coding block.

The processor 71 may be further configured to: decode the encoded syntax element of the intra-frame prediction mode of the first chrominance coding block to obtain the syntax element of the intra-frame prediction mode of the first chrominance coding block; when the encoding mode of the first chrominance coding block is determined to be the PCM mode, decode the encoded pixel information of the first chrominance coding block according to the PCM mode.

Optionally, the processor 71 may be configured to: when the encoding mode of the first luminance coding block is determined to be the PCM mode and the value of the syntax element of the intra-frame prediction mode of the first chrominance coding block is a specific value, determine the encoding mode of the first chrominance coding block to be the PCM mode.

Optionally, the processor 71 may be further configured to: decode the encoded syntax element of the intra-frame prediction mode of the first chrominance coding block to obtain the syntax element of the intra-frame prediction mode of the first chrominance coding block; according to the syntax element of the intra-frame prediction mode of the first chrominance coding block, determine that the encoding mode of the first chrominance coding block is the same as the encoding mode of the first luminance coding block; and decode the encoded pixel information of the first chrominance coding block according to the encoding mode of the first chrominance coding block.

Optionally, the different values of the syntax element of the intra-frame prediction mode of the first chrominance coding block may be one of values in a continuous second numerical range.

A specific numerical value in the continuous second numerical range may be used to indicate that the encoding mode of the first chrominance coding block is the same as the encoding mode of the first luminance coding block.

Optionally, at least part of the numerical values in the continuous second numerical range other than the specific numerical value may be used to respectively indicate that the encoding mode of the first chrominance coding block is a different chrominance intra-frame prediction mode respectively.

Optionally, the code stream of the first coding block may include a code stream of a first luminance coding block. The frame to be decoded may further include a code stream of a first chrominance coding block corresponding to the first luminance coding block.

The processor 71 may be further configured to: decode the encoded syntax element of the intra-frame prediction mode of the first chrominance coding block to obtain the syntax element of the intra-frame prediction mode of the first chrominance coding block; determine the encoding mode of the first chrominance coding block to be the PCM mode; and decode the encoded pixel information of the first chrominance coding block according to the PCM mode.

Optionally, the code stream of the first coding block may include a code stream of a first luminance coding block. The frame to be decoded may further include a code stream of a first chrominance coding block corresponding to the first luminance coding block.

Optionally, the processor 71 may be further configured to: decode the encoded syntax element of the intra-frame prediction mode of the first chrominance coding block to obtain the syntax element of the intra-frame prediction mode of the first chrominance coding block; according to the syntax element of the intra-frame prediction mode of the first chrominance coding block, determine that the encoding mode of the first chrominance coding block is a mode different from the PCM mode; and decode the encoded pixel information of the first chrominance coding block according to the encoding mode of the first chrominance coding block different from the PCM mode.

Optionally, the frame to be decoded may further include a code stream of a second coding block. The code stream of the second coding block may include an encoded syntax element of the block division mode of the second coding block, an encoded syntax element of the intra-frame prediction mode of the second coding block, and the encoded pixel information of the second coding block.

Optionally, the processor 71 may be further configured to: determine that the second coding block is one of at least two coding blocks in a second target coding block according to the encoded syntax element of the block division mode of the second coding block; and decode the encoded syntax element of the intra-frame prediction mode of the second coding block to obtain the syntax element of the intra-frame prediction mode of the second coding block; and determine the encoding mode of the second coding block according to the syntax element of the intra-frame prediction mode of the second coding block.

Optionally, the value of the syntax element of the intra-frame prediction mode of the at least two second coding blocks may be used to indicate the mode other than the PCM mode.

The value of the syntax element of the intra-frame prediction mode of the first coding block may be a value from 0 to M.

The value of the syntax element of the intra-frame prediction mode of the second coding block may be a value from 0 to M−1, where M is a positive integer.

Optionally, the syntax element of the intra-frame prediction mode with a value of M may be used to indicate the PCM mode.

As shown in FIG. 23, one embodiment of the present disclosure provides a video decoding device 80 corresponding to the video decoding method 800. Optionally, the video decoding device 80 may also correspond to new video decoding methods formed by combining the video decoding method 800 and the video decoding method 900 and/or the video decoding method 1000.

As shown in FIG. 23, the video encoding device 80 includes a processor 81 and a memory 82.

The memory 82 is configured to store a program.

The processor 81 is configured to execute the program stored in the memory 82, to execute: obtaining a code stream of a first coding block in a frame to be decoded, where the code stream of the first coding block includes encoded syntax elements of the intra-frame prediction mode of the first coding block and encoded pixel information of the first coding block; decoding the encoded syntax element of the intra-frame prediction mode of the first coding block to determine a target mode from the PCM mode and N types of intra-frame prediction mode where N is a positive integer; and decoding the encoded pixel information of the first coding block according to the target mode.

Optionally, the target mode may be indicated in the syntax element of the intra-frame prediction mode of the first coding block.

Optionally, the different values of the syntax element of the intra-frame prediction mode of the first coding block may be used to indicate the encoding mode of the first coding block is one of the N types of intra-frame prediction modes or the PCM mode, where N is a positive integer.

Optionally, the different values of the syntax element of the intra-frame prediction mode of the first coding block may be one of values in the continuous first numerical range, and the different values in the continuous first numerical range may be used to respectively indicate one of the different intra-frame prediction modes among the N types of intra-frame prediction modes or the PCM mode.

Optionally, the largest or smallest numerical value in the continuous first numerical range may be used to indicate the PCM mode.

In one embodiment, the continuous first numerical range may be 0 to M, where M is a positive integer larger than or equal to N.

Correspondingly, different numerical values from 0 to N−1 may be used to indicate different intra-frame prediction modes in the N types of intra-frame prediction modes, N may be used to indicate the PCM mode, or 0 may be used to indicate the PCM mode.

Optionally, when the target mode is one of the N types of intra-frame prediction modes, the processor 81 may be configured to: perform prediction on the encoded pixel information of the first coding block according to the target mode.

Optionally, when the target mode is the PCM mode, the processor 81 may be configured to: use the fixed-length code decoding method to decode the encoded pixel information of the first coding block according to the PCM mode.

Optionally, the code stream of the first coding block may further include a syntax element of the block division mode of the first coding block.

The processor 81 may be configured to: determine the block division mode of the first coding block according to the syntax element of the block division mode of the first coding block; and decode the encoded pixel information of the first coding block according to the PCM mode and the block division mode of the first coding block.

Optionally, the block division mode of the first coding block may be no division.

Optionally, the target mode may be the PCM mode.

Optionally, the frame to be decoded may further include a code stream of a second coding block. The code stream of the second coding block may include an encoded syntax element of the block division mode of the second coding block, and an encoded syntax element of the intra-frame prediction mode of the second coding block.

Optionally, the processor 81 may be further configured to: determine that the second coding block is one of at least two coding blocks in a second target coding block according to the encoded syntax element of the block division mode of the second coding block; and decode the encoded syntax element of the intra-frame prediction mode of the second coding block to obtain the syntax element of the intra-frame prediction mode of the second coding block.

Optionally, the value of the syntax element of the intra-frame prediction mode of the at least two second coding blocks may be used to indicate the mode other than the PCM mode.

The value of the syntax element of the intra-frame prediction mode of the first coding block may be a value from 0 to M.

The value of the syntax element of the intra-frame prediction mode of the second coding block may be a value from 0 to M−1, where M is a positive integer.

Optionally, the syntax element of the intra-frame prediction mode with a value of M may be used to indicate the PCM mode.

Optionally, the code stream of the first coding block may include a code stream of a first luminance coding block.

The frame to be decoded may further include a code stream of a first chrominance coding block corresponding to the first luminance coding block. The code stream of the first chrominance coding block may include an encoded syntax element of the intra-frame prediction mode of the first chrominance coding block and encoded pixel information of the first chrominance coding block.

The processor 81 may be further configured to: when the encoding mode of the first chrominance coding block is determined to be the PCM mode, decode the encoded pixel information of the first chrominance coding block according to the PCM mode.

Optionally, the processor 81 may be configured to: when the encoding mode of the first luminance coding block is determined to be the PCM mode and the value of the syntax element of the intra-frame prediction mode of the first chrominance coding block is a specific value, determine the encoding mode of the first chrominance coding block to be the PCM mode.

Optionally, the processor 81 may be further configured to: decode the encoded syntax element of the intra-frame prediction mode of the first chrominance coding block to obtain the syntax element of the intra-frame prediction mode of the first chrominance coding block; according to the syntax element of the intra-frame prediction mode of the first chrominance coding block, determine that the encoding mode of the first chrominance coding block is the same as the encoding mode of the first luminance coding block; and decode the encoded pixel information of the first chrominance coding block according to the encoding mode of the first chrominance coding block.

Optionally, the different values of the syntax element of the intra-frame prediction mode of the first chrominance coding block may be one of values in a continuous second numerical range.

A specific numerical value in the continuous second numerical range may be used to indicate that the encoding mode of the first chrominance coding block is the same as the encoding mode of the first luminance coding block.

Optionally, at least part of the numerical values in the continuous second numerical range other than the specific numerical value may be used to respectively indicate that the encoding mode of the first chrominance coding block is a different chrominance intra-frame prediction mode respectively.

Optionally, the code stream of the first coding block may include a code stream of a first luminance coding block. The frame to be decoded may further include a code stream of a first chrominance coding block corresponding to the first luminance coding block.

The processor 81 may be further configured to: decode the encoded pixel information of the first luminance coding block according to the target mode.

The processor 81 may be further configured to: decode the encoded pixel information of the first chrominance coding block according to the target mode using a mode same as the target mode.

Optionally, the code stream of the first coding block may include a code stream of a first luminance coding block. The frame to be decoded may further include a code stream of a first chrominance coding block corresponding to the first luminance coding block.

The processor 81 may be further configured to: decode the encoded pixel information of the first luminance coding block according to the target mode.

The processor 81 may be further configured to: decode the encoded pixel information of the first chrominance coding block according to the target mode using a mode different from the target mode.

The present disclosure also provides an electronic device. The electronic device may include any video encoding device provided by various embodiments of the present disclosure.

The processor of the embodiments of the present disclosure may be an integrated circuit chip with signal processing capability. In the implementation process, the steps of the foregoing method embodiments can be completed by hardware integrated logic circuits in the processor or instructions in the form of software. The above-mentioned processors include but are not limited to: general-purpose processors, central processing units (CPUs), digital signal processors (DSPs), application specific integrated circuits (ASICs), Field programmable gate array (FPGA) or other programmable logic devices, discrete gates or transistor logic devices, discrete hardware components. The methods, steps, and logical block diagrams disclosed in the embodiments of the present disclosure can be implemented or executed by the processors. The general-purpose processor may be a microprocessor or any conventional processor. The steps of the methods disclosed in the embodiments of the present disclosure may be directly executed and completed by a hardware decoding processor, or executed and completed by a combination of hardware and software modules in the decoding processor. The software module can be located in a mature storage medium in the field, such as random access memory, flash memory, read-only memory, programmable read-only memory, or electrically erasable programmable memory, registers. The storage medium is located in the memory, and the processor reads the information in the memory and completes the processes of the above method in combination with its hardware.

The memory of the embodiments of the present disclosure may be a volatile memory or a non-volatile memory, or may include both volatile and non-volatile memory. The non-volatile memory can be read-only memory (ROM), programmable read-only memory (PROM), erasable programmable read-only memory (EPROM), electrically erasable programmable read-only memory (EEPROM) or flash memory. The volatile memory may be random access memory (RAM), which is used as an external cache. By way of exemplary but not restrictive description, many forms of RAM are available, such as static random access memory (SRAM), dynamic random access memory (DRAM), synchronous dynamic random access memory (SDRAM), double data rate SDRAM (DDR SDRAM), enhanced synchronous dynamic random access memory (ESDRAM), synchronous connection dynamic random access memory (SLDRAM), or direct Rambus RAM (DR RAM). It should be noted that the memories of the systems and methods described herein are intended to include, but are not limited to, these and any other suitable types of memories.

The embodiments of the present disclosure also provide a computer-readable storage medium that stores one or more programs. The one or more programs include instructions, and the instructions are configured to be executed by a portable electronic device that includes multiple application programs such that the portable electronic device can be made to execute the methods provided by the embodiments shown in FIG. 3 to FIG. 19.

The embodiments of the present disclosure also provide a computer program. The computer program includes instructions, and the instructions are configured to be executed by a computer such that the computer can execute the methods provided by the embodiments shown in FIG. 3 to FIG. 19.

An embodiment of the present disclosure also provides a chip that includes an input and output interface, at least one processor, at least one memory, and a bus. The at least one memory is used to store instructions, and the at least one processor is used to call the instructions in the at least one memory, to execute the methods provided by the embodiments shown in FIG. 3 to FIG. 19.

The units and algorithm steps described in the embodiments disclosed herein can be implemented by hardware, software, firmware, or any combination thereof. When the embodiments in the present disclosure are implemented by software, it can be implemented in the form of a computer program product in whole or in part. The computer program product can include one or more computer instructions. When the computer program instructions are loaded and executed on the computer, the processes or functions described in the embodiments of the present disclosure are generated in whole or in part. The computer may be a general-purpose computer, a special-purpose computer, a computer network, or another programmable device. The computer instructions may be stored in a computer-readable storage medium, or transmitted from one computer-readable storage medium to another computer-readable storage medium. For example, the computer instructions may be transmitted from a website, computer, server, or data center, to another website, computer, server or data center via wired (such as coaxial cable, optical fiber, digital subscriber line (DSL)) or wireless (such as infrared, wireless, microwave, etc.) manner. The computer-readable storage medium may be any available medium that can be accessed by a computer or a data storage device such as a server or data center integrated with one or more available media. The usable medium may be a magnetic medium (for example, a floppy disk, a hard disk, a magnetic tape), an optical medium (for example, a digital video disc (DVD)), or a semiconductor medium (for example, a solid state disk (SSD)), etc.

A person of ordinary skill in the art can be aware that the units and algorithm steps described in the embodiments disclosed herein can be implemented by electronic hardware, computer software, or a combination of both. To clearly illustrate the hardware and software interchangeability, in the above description, the composition and steps of each example have been generally described in accordance with the function. Whether these functions are executed by hardware or software depends on the specific application and design constraint conditions of the technical solution. Professionals and technicians can use different methods for each specific application to implement the described functions, but such implementation should not be considered beyond the scope of the present disclosure

Those skilled in the art can clearly understand that, for the convenience and conciseness of description, the specific working processes of the above-described system, device, and unit is not repeated, and reference can be made to the corresponding processes described in the foregoing method embodiments.

In the embodiments provided in the present disclosure, the disclosed system, device, and method may be implemented in other ways. For example, the device embodiments described above are only illustrative. For example, the division of the units is only a logical function division, and there may be other divisions in actual implementation. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may also be electrical, mechanical or other forms of connection.

The units described as separate components may or may not be physically separated, and the components displayed as units may or may not be physical units, that is, they may be located in one place, or they may be distributed on multiple network units. Some or all of the units may be selected according to actual needs to achieve the objectives of the solutions of the embodiments of the present disclosure.

In addition, the functional units in the various embodiments of the present disclosure may be integrated into one processing unit, or each unit may exist alone physically, or two or more units may be integrated into one unit. The above-mentioned integrated unit can be implemented in the form of hardware or software functional unit.

When the integrated unit is implemented in the form of a software functional unit and sold or used as an independent product, it can be stored in a computer readable storage medium. Based on this understanding, all or part of the technical solution can be embodied in the form of a software product. The computer software product is stored in a storage medium, and includes several instructions to enable a computer device (which may be a personal computer, a server, or a network device, etc.) to perform all or part of the steps of the method described in each embodiment of the present disclosure. The aforementioned storage medium includes: a U disk, a mobile hard disk, a read-only memory (ROM), a random access memory (RAM), a magnetic disk, an optical disk, or another medium that can store program codes.

The above are only specific implementations of embodiments of the present disclosure, but the scope of the present disclosure is not limited to this. Anyone familiar with the technical field can easily think of various equivalents within the technical scope disclosed in the present disclosure. These modifications or replacements shall be covered within the scope of the present disclosure. Therefore, the protection scope of the present disclosure shall be subject to the protection scope of the claims.

What is claimed is:

1. A video encoding method comprising:
selecting a pulse code modulation (PCM) mode to encode a coding block in a frame to be encoded; and
indicating the PCM mode in a syntax element of intra-frame prediction mode of the coding block.

2. The method according to claim 1, wherein a value of the syntax element is one of a plurality of values each indicating one of a plurality of candidate encoding modes, the plurality of candidate encoding modes include N types of intra-frame prediction modes and the PCM mode, and N being a positive integer.

3. The method according to claim 2, wherein the plurality of values are numerical values in a continuous numerical range.

4. The method according to claim 3, wherein a largest or smallest numerical value in the continuous numerical range is used to indicate the PCM mode.

5. The method according to claim 3, wherein:
the continuous numerical range is 0 to M, M being a positive integer larger than or equal to N; and
different numerical values from 0 to N−1 are used to indicate different intra-frame prediction modes of the N types of intra-frame prediction modes, and N is used to indicate the PCM mode; or 0 is used to indicate the PCM mode.

6. The method according to claim 2, wherein selecting the PCM mode to encode the coding block includes:
selecting the PCM mode from the plurality of candidate encoding modes to encode the coding block.

7. The method according to claim 6, further comprising, before selecting the PCM mode from the plurality of candidate encoding modes:
calculating rate distortion costs of the plurality of candidate encoding modes;
wherein selecting the PCM mode from the plurality of candidate encoding modes includes, in response to the rate distortion cost of the PCM mode being smallest among the rate distortion costs, selecting the PCM mode.

8. The method according to claim 1, wherein encoding the coding block includes:
using a fixed-length code encoding method to encode the coding block based on the PCM mode.

9. The method according to claim 1, further comprising:
selecting a specific division mode from a plurality of division modes to perform block division on a target coding block in the frame to be encoded to obtain the coding block.

10. The method according to claim 9, further comprising, before selecting the specific division mode from the plurality of division modes:
calculating rate distortion costs of the plurality of division modes;
wherein selecting the specific division mode includes selecting one of the plurality of division modes that has a smallest rate distortion cost among the plurality of division modes as the specific division mode.

11. A video decoding method comprising:
obtaining a code stream of a coding block of a frame to be decoded, the code stream including an encoded syntax element of intra-frame prediction mode of the coding block and encoded pixel information of the coding block;
decoding the encoded syntax element to obtain a syntax element of intra-frame prediction mode of the coding block;
determining a pulse code modulation (PCM) mode according to the syntax element; and
decoding the encoded pixel information according to the PCM mode.

12. The method according to claim 11, wherein a value of the syntax element is one of a plurality of values each indicating one of a plurality of candidate encoding modes, the plurality of candidate encoding modes include N types of intra-frame prediction modes and the PCM mode, and N being a positive integer.

13. The method according to claim 12, wherein the plurality of values are numerical values in a continuous numerical range.

14. The method according to claim 13, wherein a largest or smallest numerical value in the continuous numerical range is used to indicate the PCM mode.

15. The method according to claim 13, wherein:
the continuous numerical range is 0 to M, M being a positive integer larger than or equal to N; and
different numerical values from 0 to N−1 are used to indicate different intra-frame prediction modes of the N types of intra-frame prediction modes, and N is used to indicate the PCM mode; or 0 is used to indicate the PCM mode.

16. The method according to claim 11, wherein decoding the encoded pixel information includes:
using a fixed-length code decoding method to decode the encoded pixel information based on the PCM mode.

17. The method according to claim 11, wherein:
the encoded syntax element is a first encoded syntax element;
the code stream further includes a second encoded syntax element of a block division mode of the coding block; and
decoding the encoded pixel information according to the PCM mode includes:
determining the block division mode of the coding block according to the second encoded syntax element; and
decoding the encoded pixel information according to the block division mode and the PCM mode.

18. The method according to claim 17, wherein the block division mode is no division.

19. The method according to claim 11,
wherein:
the code stream of the coding block includes a code stream of a luminance coding block;
the frame to be decoded further includes a code stream of a chrominance coding block corresponding to the luminance coding block; and
the code stream of the chrominance block includes an encoded syntax element of intra-frame prediction mode of the chrominance block and encoded pixel information of the chrominance block;
the method further comprising:
decoding the encoded syntax element of the chrominance block to determine that an encoding mode of the chrominance block is the PCM mode; and
decoding the encoded pixel information of the chrominance block according to the PCM mode.

20. The method according to claim 19, wherein determining that the encoding mode of the chrominance block is the PCM mode includes:
determining that the encoding mode of the chrominance block is the PCM mode in response to determining that an encoding mode of the luminance coding block is the PCM mode and a value of the syntax element of the chrominance coding block is a specific value.
